(19) United States
(12) Patent Application Publication
(10) Pub. No.: US 2016/0118179 A1
(43) Pub. Date: Apr. 28, 2016

(54) WIRELESS POWER TRANSFER DEVICE AND WIRELESS CHARGING SYSTEM HAVING SAME

(71) Applicant: LG ELECTRONICS INC., Yeongdeungpo-gu Seoul (KR)

(72) Inventors: Jinmoo PARK, Seoul (KR); Kihyun JUNG, Seoul (KR); Jihyun LEE, Seoul (KR); Hyunbeom LEE, Seoul (KR); Jaesung LEE, Seoul (KR)

(73) Assignee: LG ELECTRONICS INC., Seoul (KR)

(21) Appl. No.: 14/764,874

(22) PCT Filed: Jan. 24, 2014
(86) PCT No.: PCT/KR2014/000700

§ 371 Date: Jul. 30, 2015

Related U.S. Application Data
(60) Provisional application No. 61/760,448, filed on Feb. 4, 2013.

(30) Foreign Application Priority Data
Jan. 21, 2014 (KR) 10-2014-0007394

(51) Int. Cl. H01F 27/28; H02J 7/04; H01F 38/14; H02J 7/02

(52) U.S. Cl. CPC H01F 27/2823; H02J 7/025; H02J 7/04; H01F 27/2885; H01F 38/14

(57) ABSTRACT

According to an embodiment of the present invention, a wireless power transmitter comprises a base station configured to supply power to a portable electronic device, a coil formed in a manner of winding a wire and configured to convert a current into a magnetic flux, and a shielding unit configured to shield the base station from a magnetic field generated in the coil, wherein the coil has a triangular shape and is formed into a single layer.

### TECHNICAL FIELD

The present disclosure relates to a wireless power transmitter (or a wireless power transfer device) for transmitting power in a wireless manner using electromagnetic induction, a wireless power receiver, and a wireless charging system.

### BACKGROUND ART

In recent time, a wireless charging method without the need of an inconvenient process of connecting a wire for charging a portable electronic product. With the introduction of the standardization of an inductive wireless charging technology, wireless charging is rapidly put to practical use.

The wireless charging method is an energy transfer concept which goes beyond the conventional method of charging an electronic device by transferring power through a wire and transfers energy in a wireless manner using an electromagnetic induction principle and magnetic coupling. The wireless charging method includes a method using electromagnetic induction and a method using magnetic resonance.

Technically, it has been well-known that the magnetic resonance method can be applied even when transmitter and receiver are located at positions farther away from each other or with a long distance therebetween, compared with the induction method. However, a more extended time for the practical use is required for the magnetic resonance method and its standardization is in slow progress. On the other hand, the standardization and manufacturing of technologies for the induction method are in fast progress. Hence, it is important to ensure a technology of increasing the distance and positions even with using the induction method.

Up to now, when using a wireless charger which has been manufactured by employing the induction method, it can be confirmed that an apparatus or device desired to be charged should be well aligned with a center of the charger. Depending on products, a method of aligning centers of a transmitter and a receiver is applied or an auxiliary method of aligning the centers of the transmitter and the receiver using a magnet is employed.

To this end, as a method of enabling charging even the receiver is misaligned with respect to the transmitter by improving a transmission-reception method using a single coil, a method of extending (increasing, widening) a region on which the receiver can be placed by an arrangement of several coils may be taken into account. Also, even tough using a single coil, a method of recognizing the receiver and relocating a transmitting coil of the transmitter to a position where the receiver is located may be considered.

However, for the use of the plurality of coils, a power control for the coils may be difficult and fabricating costs may increase. Also, for the use of the single coil, fabricating costs may increase due to the addition of a mechanism for the relocation. Therefore, a structure which can more effectively extend an operation region of a wireless power transmitter may be considered.

### DISCLOSURE OF THE INVENTION

Therefore, to obviate those problems, an aspect of the detailed description is to increase (or extend) an active area of a wireless power transmitter.

Another aspect of the detailed description is to employ a single-layered coil, other than a multi-layered coil, for a wireless power transmitter.

Another aspect of the detailed description is to propose effect shape and size of a transmitting coil for an electromagnetic induction type wireless power transmitter.

To achieve these and other advantages and in accordance with the purpose of the present invention, as embodied and broadly described herein, there is provided a wireless power transmitter including a base station configured to supply power to the portable electronic device, a coil formed in a manner of winding a wire and configured to convert a current into a magnetic flux, and a shielding unit configured to shield the base station from a magnetic field generated in the coil, wherein the coil is formed into a single layer in a shape of a triangle.

In accordance with one embodiment of the present invention, the shielding unit may overlap the coil, and at least part thereof may exceed an outer diameter of the coil.

The shielding unit may extend from the outer diameter of the coil by at least 2.5 mm, and may be arranged below the coil by the maximum distance of 1.0 mm. The shielding unit may have a thickness of at least 0.7 mm. The wireless power transmitter may further include a body tiltably connected to the base station, the shielding unit may be located between a case of the base station and the coil.

In accordance with one embodiment of the present invention, a distance from the coil to one surface (interface surface) of the base station may be 3.0±0.5 mm.

In accordance with one embodiment of the present invention, the wireless power transmitter may use full bridge and half-bridge inverter topologies as well as capacitance to operate the coil. Self-inductances of the coil and the shielding unit within driving frequency ranges related to the full-bridge and half-bridge inverter topologies may be 7.8±10% μH.

In accordance with one embodiment of the present invention, the single layer may be formed in a manner that a wire is wound along sides of an isosceles triangle on the same plane. The isosceles triangle may have a height longer than a base line thereof. The coil may have an outer height of 68±0.5 mm, an outer width of 59±0.5 mm, an inner height of 44±0.5 mm, and an inner width of 35±0.5 mm.

The coil may have a thickness of 1.5±0.5 mm. The wire may be wound eight (8) times in the single layer. The coil may be formed of a 16 WAG litz wire of 180 strands of a diameter of 0.8 mm or corresponding numerals.

The present invention provides a portable electronic device charged by a wireless power transmitter. A receiving coil unit of the portable electronic device may include a coil formed in a manner of winding a wire, and configured to convert a current into a magnetic flux. The coil may be formed into a single layer in a shape of a rectangle. The coil may receive the magnetic flux from a coil of the wireless power transmitter, which is formed into a single layer in a shape of a triangle.

### Advantageous Effect

In a wireless power transmitter according to at least one embodiment of the detailed description, this specification can provide a wireless power transmitter having a single coil with an active area, which is substantially the same level as or greater than that of a multi-coil, even without use of such multi-coil.

In a wireless power transmitter according to at least one embodiment of the detailed description, a shielding unit can be reduced in thickness by allowing a coil unit to be structurally spaced apart from a circuit unit.

### BRIEF DESCRIPTION OF THE DRAWINGS

FIG. 1 is an exemplary view conceptually illustrating a wireless power transmitter and an electronic device according to embodiments of the present invention.

FIGS. 2A and 2B are exemplary block diagrams illustrating the configurations of a wireless power transmitter 100 and an electronic device 200 that can be employed in the embodiments disclosed herein, respectively.

FIG. 3 is a view illustrating a concept in which power is transferred from a wireless power transmitter to an electronic device in a wireless manner according to an inductive coupling method.

FIG. 4A and FIG. 4B are a block diagram illustrating parts of the wireless power transmitter 100 and the electronic device 200 in a magnetic induction method that can be employed in the embodiments disclosed herein.

FIG. 5 is a block diagram illustrating a wireless power transmitter configured to have one or more transmitting coils receiving power according to an inductive coupling method that can be employed in the embodiments disclosed herein.

FIG. 6 is a view illustrating a concept in which power is transferred to an electronic device from a wireless power transmitter in a wireless manner according to a resonance coupling method.

FIG. 7A and FIG. 7B are a block diagram exemplarily illustrating parts of the wireless power transmitter 100 and the electronic device 200 in a resonance method that can be employed in the embodiments disclosed herein.

FIG. 8 is a block diagram illustrating a wireless power transmitter configured to have one or more transmitting coils receiving power according to a resonance coupling method that can be employed in the embodiments disclosed herein.

FIG. 9 is a block diagram illustrating a wireless power transmitter further comprising additional constituent elements in addition to the constituent elements illustrated in FIG. 2A.

FIG. 10 is a view illustrating a configuration when the electronic device 200 in accordance with the exemplary embodiments is implemented as a mobile terminal.

FIG. 11A is a front perspective view of a charger (or a charging device) in accordance with one embodiment disclosed herein.

FIGS. 11B and 11C are status views illustrating examples in which a mobile terminal is arranged to be charged by the charger illustrated in FIG. 11A, respectively.

FIG. 12 is a front perspective view of a mobile terminal in accordance with one embodiment disclosed herein.

FIG. 13 is a rear perspective view of the mobile terminal illustrated in FIG. 12.

FIG. 14 is an exploded perspective view of a second body constructing the charger illustrated in FIG. 11A.

FIG. 15 is a conceptual view illustrating a transmitting coil unit coupled to a shielding unit.

FIG. 16 is a conceptual view illustrating the transmitting coil unit coupled to a shielding unit.

FIGS. 17A and 17B are views illustrating configurations of circuits operating in a full-bridge mode and a half-bridge mode according to the present invention.

FIG. 18 is a view illustrating that charging is enabled regardless of sizes or placed positions of mobile terminals which are charged by the charger.

FIG. 19 is a conceptual view illustrating an exemplary coil constructing a receiving coil unit of a wireless power receiver.

### MODES FOR CARRYING OUT THE PREFERRED EMBODIMENTS

The technologies disclosed herein may be applicable to wireless power transfer (contactless power transfer). However, the technologies disclosed herein are not limited to this, and may be also applicable to all kinds of power transmission systems and methods, wireless charging circuits and methods to which the technological spirit of the technology can be applicable, in addition to the methods and apparatuses using power transmitted in a wireless manner.

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

In addition, a suffix “module” or “unit” used for constituent elements disclosed in the following description is merely intended for easy description of the specification, and the suffix itself does not give any special meaning or function.

Furthermore, the terms including an ordinal number such as first, second, etc. can be used to describe various elements, but the elements should not be limited by those terms. The terms are used merely for the purpose to distinguish an element from the other element. For example, a first element may be named to a second element, and similarly, a second element may be named to a first element without departing from the scope of right of the invention.

Hereinafter, preferred embodiments of the present invention will be described in detail with reference to the accompanying drawings, and the same or similar elements are designated with the same numeral references regardless of the numerals in the drawings and their redundant description will be omitted.

In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings.

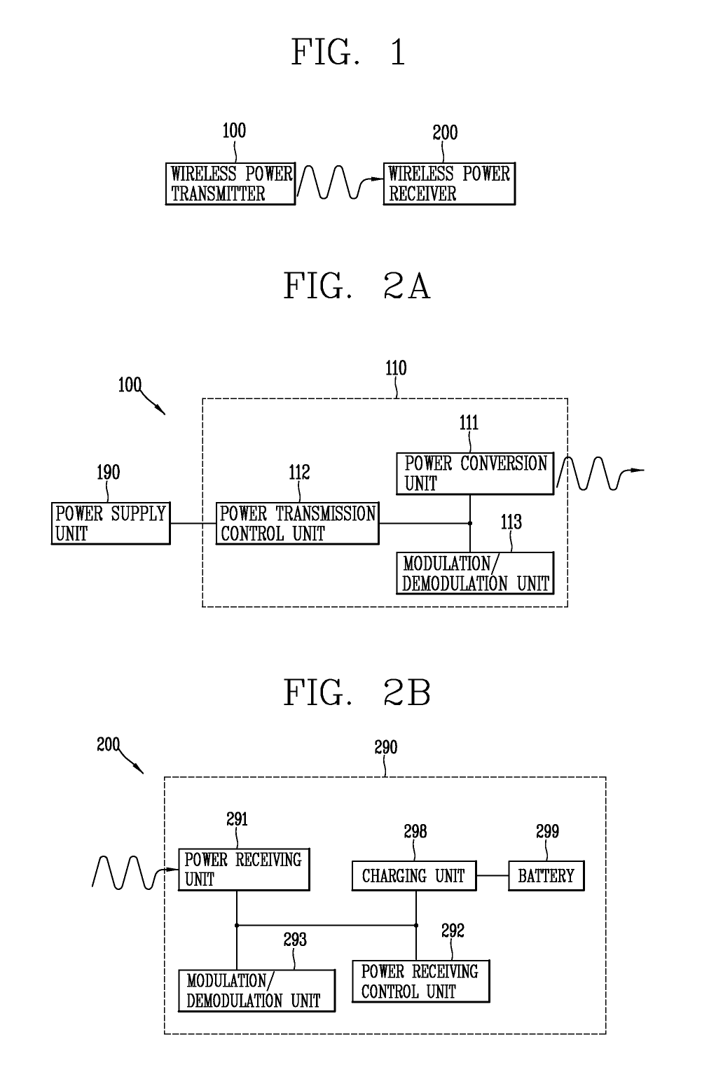

FIG. 1—Conceptual View of Wireless Power Transmitter and Electronic Device

FIG. 1 is an exemplary view conceptually illustrating a wireless power transmitter and a wireless power receiver according to the embodiments of the present invention.

Referring to FIG. 1, the wireless power transmitter 100 may be a power transfer device configured to transfer power required for the wireless power receiver 200 in a wireless manner.

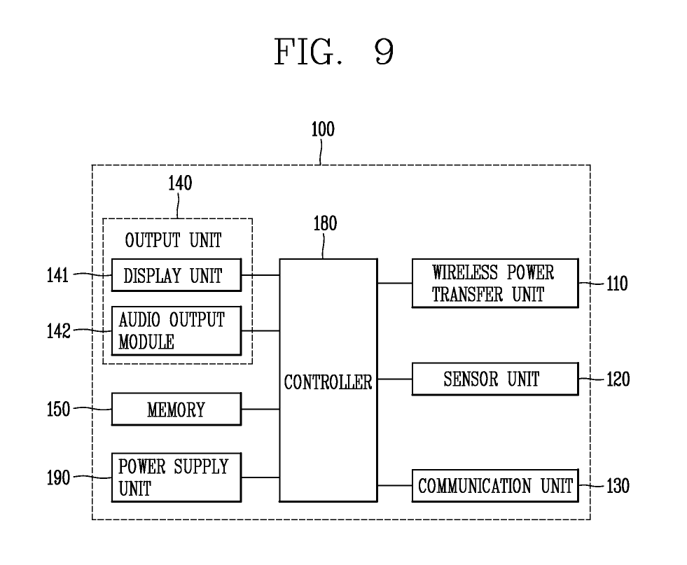

Furthermore, the wireless power transmitter 100 may be a wireless charging apparatus (a wireless charging device or a wireless charger) configured to charge a battery of the electronic device 200 by transferring power in a wireless manner. A case where the wireless power transmitter 100 is a wireless charging apparatus will be described later with reference to FIG. 9.

Additionally, the wireless power transmitter 100 may be implemented with various forms of apparatuses transferring power to the electronic device 200 requiring power in a contactless state.

The electronic device 200 is a device that is operable by receiving power from the wireless power transmitter 100 in a wireless manner. Furthermore, the electronic device 200 may charge a battery using the received wireless power.

On the other hand, an electronic device for receiving power in a wireless manner as described herein should be construed broadly to include a portable phone, a cellular phone, a smart phone, a personal digital assistant (PDA), a portable multimedia player (PMP), a tablet, a multimedia device, or the like, in addition to an input/output device such as a keyboard, a mouse, an audio-visual auxiliary device, and the like.

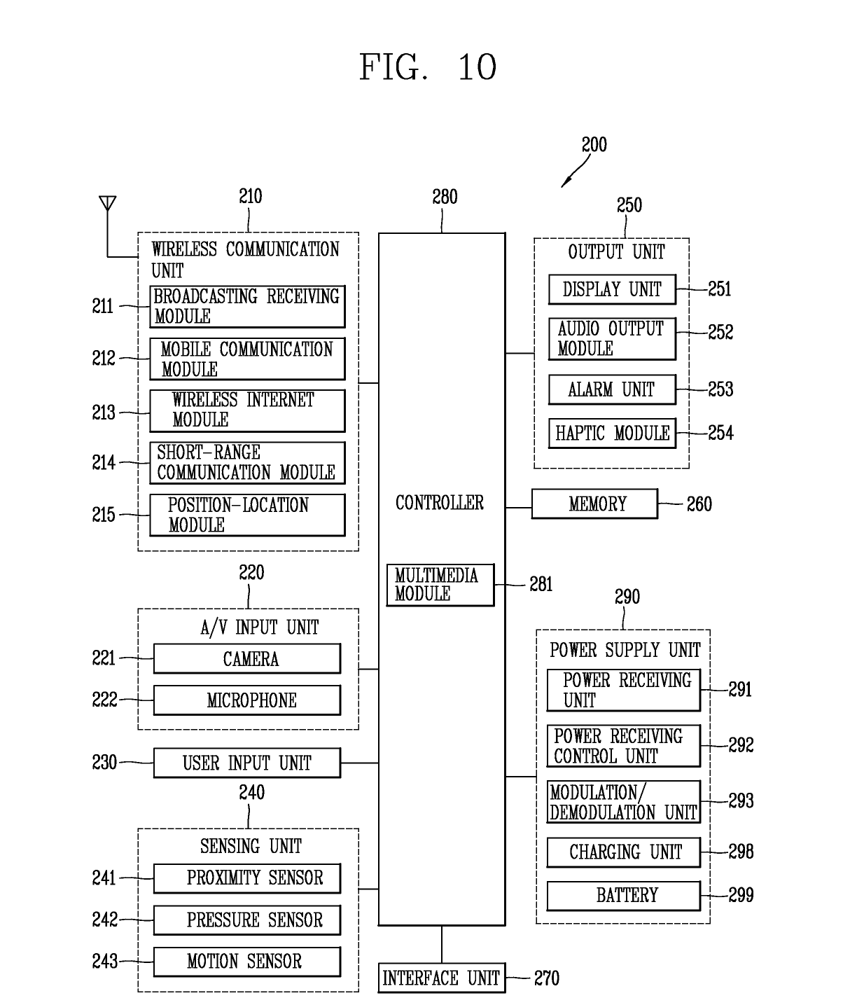

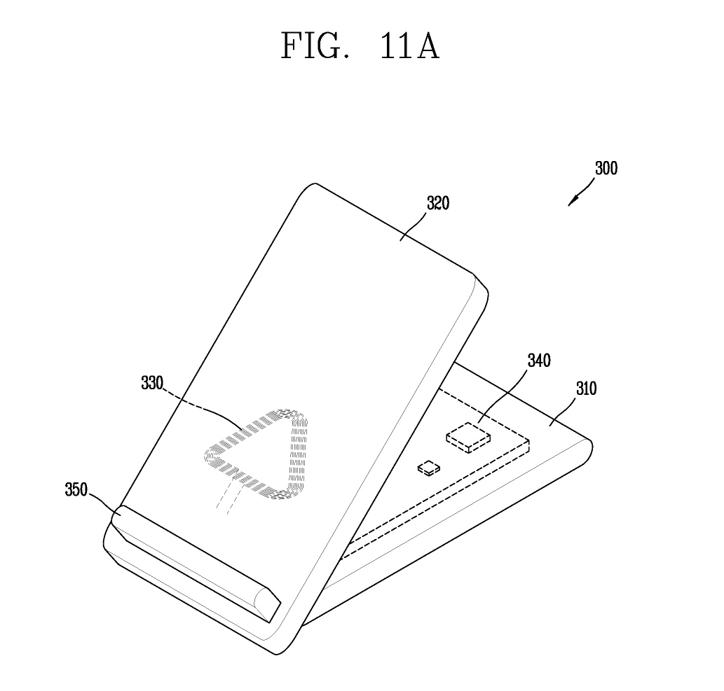

The electronic device 200, as will be described later, may be a mobile communication terminal (for example, a portable phone, a cellular phone, a tablet and the like) or a multimedia device. An exemplary embodiment in which the electronic device 200 is implemented as a mobile terminal will be described later with reference to FIG. 10.

On the other hand, the wireless power transmitter 100 may transfer power in a wireless manner without mutual contact to the electronic device 200 using one or more wireless power transfer methods. In other words, the wireless power transmitter 100 may transfer power using at least one of an inductive coupling method based on magnetic induction phenomenon by the wireless power signal and an electromagnetic resonance coupling method based on electromagnetic resonance phenomenon by a wireless power signal at a specific frequency.

Wireless power transfer in the inductive coupling method is a technology transferring power in a wireless manner using a primary coil and a secondary coil, and refers to the transmission of power by inducing a current from a coil to another coil through a changing magnetic field by a magnetic induction phenomenon.

Wireless power transfer in the inductive coupling method refers to a technology in which the electronic device 200 generates electromagnetic resonance by a wireless power signal transmitted from the wireless power transmitter 100 to transfer power from the wireless power transmitter 100 to the electronic device 200 by the resonance phenomenon.

Hereinafter, the wireless power transmitter 100 and the electronic device 200 according to the embodiments disclosed herein will be described in detail. In assigning reference numerals to the constituent elements in each of the following drawings, the same reference numerals will be used for the same constituent elements even though they are shown in a different drawing.

FIG. 2A and FIG. 2B are an exemplary block diagram illustrating the configuration of a wireless power transmitter 100 and an electronic device 200 that can be employed in the embodiments disclosed herein.

FIG. 2A—Wireless Power Transmitter

Referring to FIG. 2A, the wireless power transmitter 100 may include a power transmission unit 110. The power transmission unit 110 may include a power conversion unit 111 and a power transmission control unit 112.

The power conversion unit 111 transfers power supplied from a transmission side power supply unit 190 to the electronic device 200 by converting it into a wireless power signal. The wireless power signal transferred by the power conversion unit 111 is generated in the form of a magnetic field or electro-magnetic field having an oscillation characteristic. For this purpose, the power conversion unit 111 may be configured to include a coil for generating the wireless power signal.

The power conversion unit 111 may include a constituent element for generating a different type of wireless power signal according to each power transfer method.

For example, the power conversion unit 111 may include a primary coil for forming a changing magnetic field to induce a current to a secondary coil of the electronic device 200. Furthermore, the power conversion unit 111 may include a coil (or antenna) for forming a magnetic field having a specific resonant frequency to generate a resonant frequency in the electronic device 200 according to the resonance coupling method.

Furthermore, the power conversion unit 111 may transfer power using at least one of the foregoing inductive coupling method and the resonance coupling method.

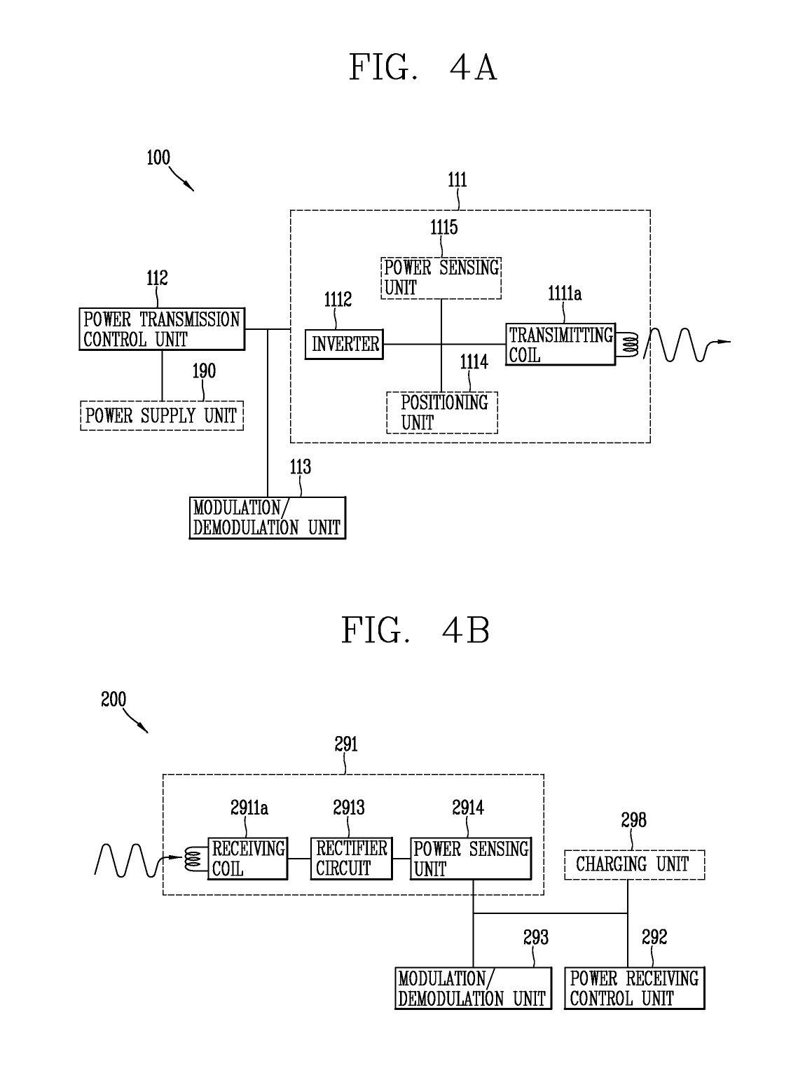

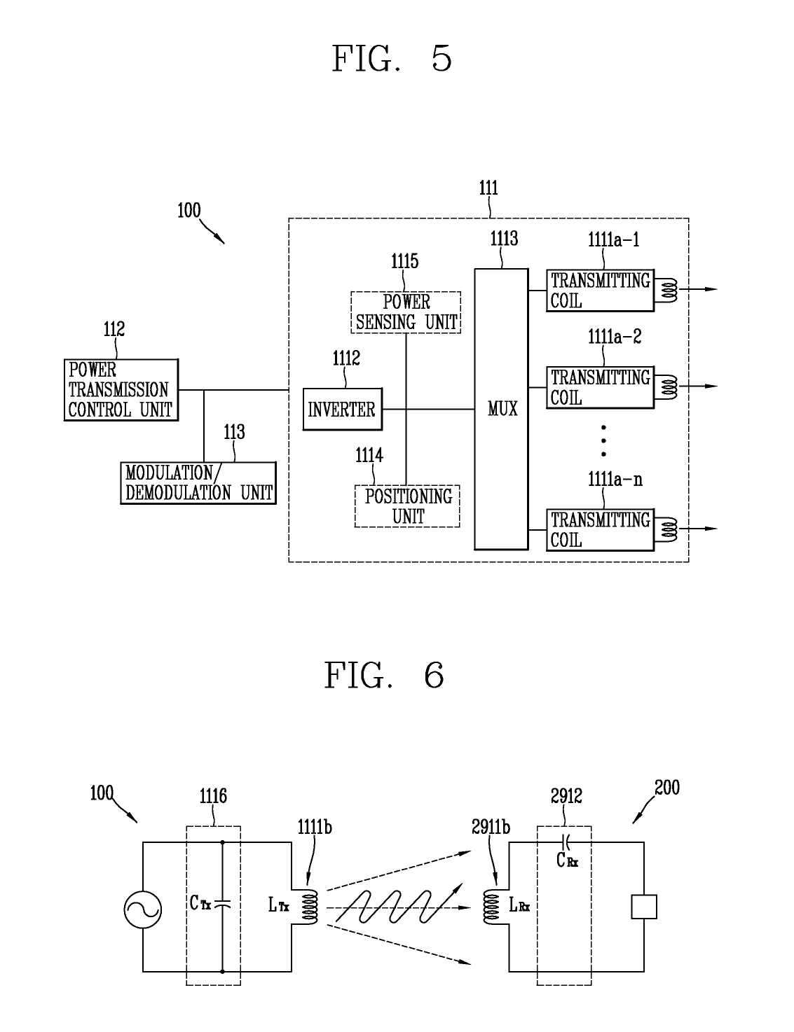

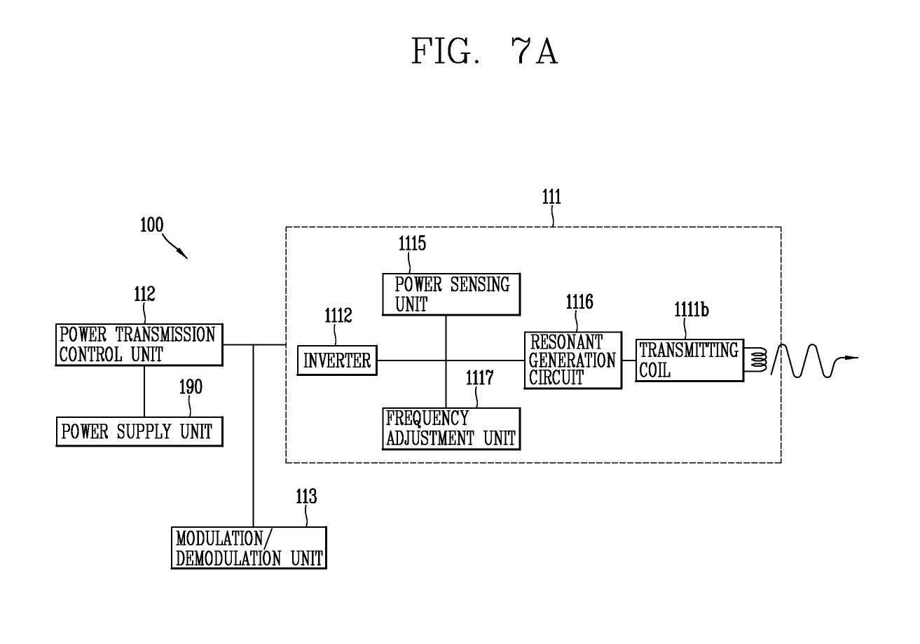

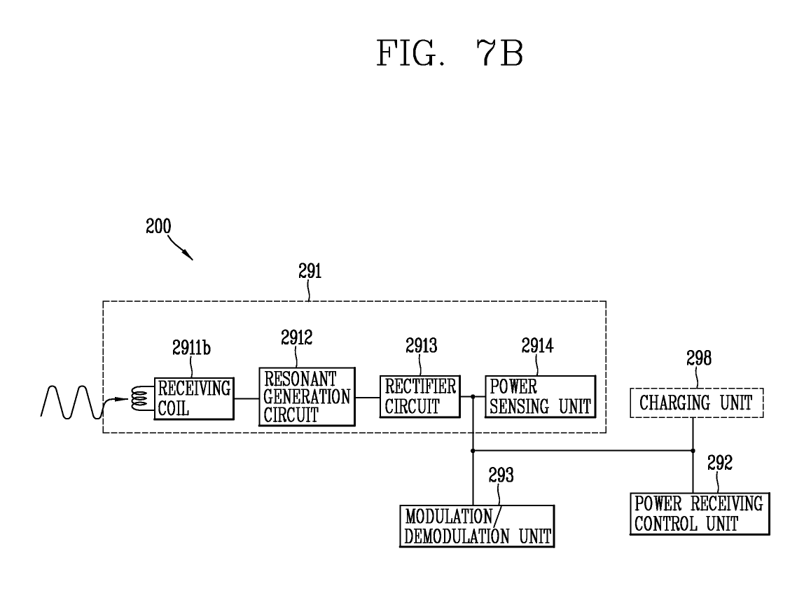

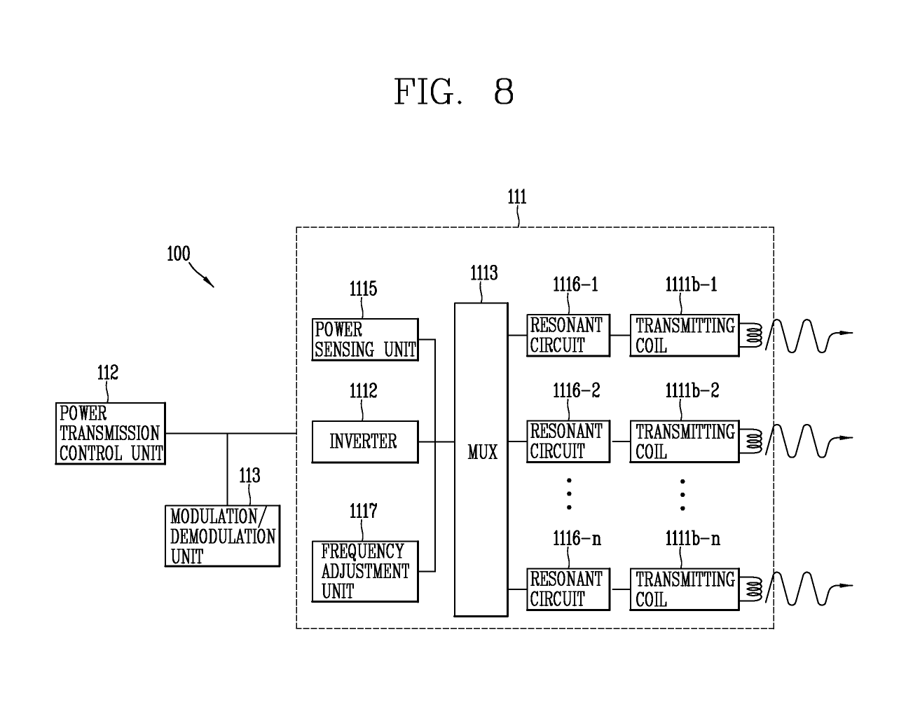

Among the constituent elements included in the power conversion unit 111, those for the inductive coupling method will be described later with reference to FIGS. 4A, 4B and 5, and those for the resonance coupling method will be described with reference to FIGS. 7A, 7B and 8.

On the other hand, the power conversion unit 111 may further include a circuit for controlling the characteristics of a used frequency, an applied voltage, an applied current or the like to form the wireless power signal.

The power transmission control unit 112 controls each of the constituent elements included in the power transmission unit 110 The power transmission control unit 112 may be implemented to be integrated into another control unit (not shown) for controlling the wireless power transmitter 100.

On the other hand, a region which the wireless power signal can be approached may be divided into two types. First, an active area denotes a region through which a wireless power signal transferring power to the electronic device 200 is passed. Next, a semi-active area denotes an interest region in which the wireless power transmitter 100 can detect the existence of the electronic device 200. Here, the power transmission control unit 112 may detect whether the electronic device 200 is placed in the active area or detection area or removed from the area. Specifically, the power transmission control unit 112 may detect whether or not the electronic device 200 is placed in the active area or detection area using a wireless power signal formed from the power conversion unit 111 or a sensor separately provided therein. For instance, the power transmission control unit 112 may detect the presence of the electronic device 200 by monitoring whether or not the characteristic of power for forming the wireless power signal is changed by the wireless power signal, which is affected by the electronic device 200 existing in the detection area. However, the active area and detection area may vary according to the wireless power transfer method such as an inductive coupling method, a resonance coupling method, and the like.

The power transmission control unit 112 may perform the process of identifying the electronic device 200 or determine whether to start wireless power transfer according to a result of detecting the existence of the electronic device 200.

Furthermore, the power transmission control unit 112 may determine at least one characteristic of a frequency, a voltage, and a current of the power conversion unit 111 for forming the wireless power signal. The determination of the characteristic may be carried out by a condition at the side of the wireless power transmitter 100 or a condition at the side of the wireless power receiver 200. In some embodiments, the power transmission control unit 112 may decide the characteristic based on identification information related to the electronic device 200. In some embodiments, the power transmission control unit 112 may decide the characteristic based on required power information of the electronic device 200 or profile information related to the required power. The power transmission control unit 112 may receive a power control message from the electronic device 200. The power transmission control unit 112 may determine at least one characteristic of a frequency, a voltage and a current of the power conversion unit 111 based on the received power control message, and additionally perform other control operations based on the power control message.

For example, the power transmission control unit 112 may determine at least one characteristic of a frequency, a voltage and a current used to form the wireless power signal according to the power control message including at least one of rectified power amount information, charging state information and identification information in the wireless power receiver 200.

Furthermore, as another control operation using the power control message, the wireless power transmitter 100 may perform a typical control operation associated with wireless power transfer based on the power control message. For example, the wireless power transmitter 100 may receive information associated with the wireless power receiver 200 to be auditorily or visually outputted through the power control message, or receive information required for authentication between devices.

In exemplary embodiments, the power transmission control unit 112 may receive the power control message through the wireless power signal. In other exemplary embodiment, the power transmission control unit 112 may receive the power control message through a method for receiving user data.

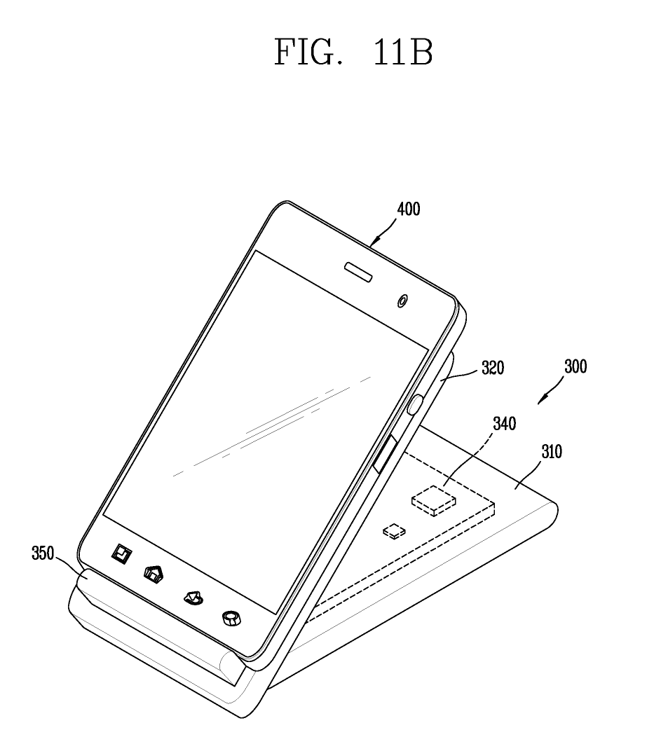

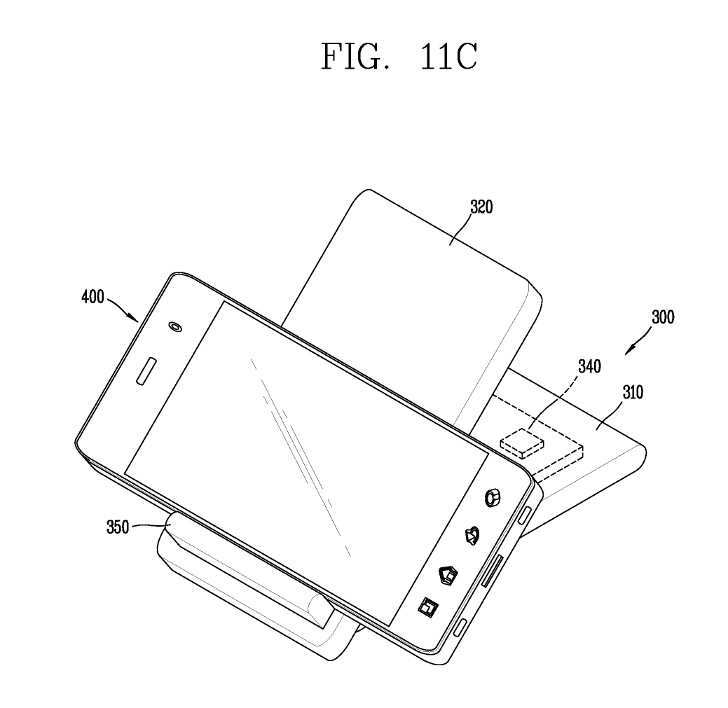

In order to receive the foregoing power control message, the wireless power transmitter 100 may further include a modulation/demodulation unit 113 electrically connected to the power conversion unit 111. The modulation/demodulation unit 113 may modulate a wireless power signal that has been modulated by the wireless power receiver 200 and use it to receive the power control message. A method in which the power conversion unit 111 receives a power control message using a wireless power signal will be explained later with reference to FIG. 11A to FIG. 13.

In addition, the power transmission control unit 112 may acquire a power control message by receiving user data including a power control message by a communication means (not shown) included in the wireless power transmitter 100.

In accordance with one embodiment disclosed herein, the wireless power transmitter 100 may supply power to a plurality of electronic devices (or wireless power receivers). In this instance, modulated wireless power signals may collide with one another due to the plurality of electronic devices. Therefore, the constituent elements included in the wireless power transmitter 100 may perform various operations for avoiding collision of the modulated wireless power signals.

In accordance with one embodiment, the power conversion unit 111 may convert power supplied from the transmitting side power supply unit 190 into a wireless power signal and transfer the wireless power signal to the plurality of electronic devices, respectively. For example, the plurality of electronic devices may be two electronic devices, namely, a first electronic device and a second electronic device.

Also, the power conversion unit 111 may generate a wireless power signal for power transfer and receive a first response signal and a second response signal corresponding to the wireless power signal.

The power transmission control unit 112 may determine whether or not the first response signal and the second response signal collide with each other, and reset the power transfer when it is determined that the first response signal and the second response signal collide with each other.

The first response signal and the second response signal may be generated in a manner that the wireless power signal is modulated by the first device and the second device, respectively.

Also, the power transmission control unit 112 may control the power conversion unit 111 in such a manner that the first response signal and the second response signal, which are generated to avoid collision with each other according to the resetting result of the power transfer, can be received in a sequential manner.

The sequential reception indicates a reception of the first response signal after a first time interval and then the second response signal after a second time interval within a predetermined response period. The first time interval and the second time interval may be decided based on a value obtained by generating random numbers.

The predetermined response period (Tping interval) may be decided to be more than a time which may include both the first response signal and the second response signal, and also decided after resetting the power transfer.

In accordance with one exemplary embodiment disclosed herein, the determination as to whether those signals collide with each other may be carried out according to whether or not the first response signal and the second response signal are decoded using a preset format. The preset format may include a preamble, a header and a message. The determination as to whether or not the first response signal and the second response signal collide with each other may be carried out based on whether or not it is possible to restore the first response signal and the second response signal because an error is generated due to collision in at least one of the preamble, the header and the message.

Also, in accordance with one exemplary embodiment disclosed herein, the power conversion unit 111 may receive the response signal of the first device which does not collide with the response signal of the second device periodically within a first response period (Tping interval_1). The power transmission control unit may decode the first response signal and the second response signal using a preset format, and determine whether or not the first response signal and the second response signal collide with each other based on possibility of the decoding. Here, the first response signal and the second response signal may be received periodically within a second response period (Tping interval_2). The second response period (Tping interval_2) may be decided to be more than a time, which may include both the first response signal and the second response signal, and also decided after resetting the power transfer.

FIG. 2B—Electronic Device

Referring to FIG. 2B, the electronic device 200 may include a power supply unit 290. The power supply unit 290 supplies power required for the operation of the electronic device 200. The power supply unit 290 may include a power receiving unit 291 and a power reception control unit (or POWER RECEIVING CONTROL UNIT) 292.

The power receiving unit 291 receives power transferred from the wireless power transmitter 100 in a wireless manner.

The power receiving unit 291 may include constituent elements required to receive the wireless power signal according to a wireless power transfer method. Furthermore, the power receiving unit 291 may receive power according to at least one wireless power transfer method, and in this case, the power receiving unit 291 may include constituent elements required for each method.

First, the power receiving unit 291 may include a coil for receiving a wireless power signal transferred in the form of a magnetic field or electromagnetic field having an oscillation characteristic.

For instance, as a constituent element according to the inductive coupling method, the power receiving unit 291 may include a secondary coil to which a current is induced by a changing magnetic field. In exemplary embodiments, the power receiving unit 291, as a constituent element according to the resonance coupling method, may include a coil and a resonant circuit in which resonance phenomenon is generated by a magnetic field having a specific resonant frequency.

In another exemplary embodiments, when the power receiving unit 291 receives power according to at least one wireless power transfer method, the power receiving unit 291 may be implemented to receive power by using a coil, or implemented to receive power by using a coil formed differently according to each power transfer method.

Among the constituent elements included in the power receiving unit 291, those for the inductive coupling method will be described later with reference to FIG. 4A or 4B, and those for the resonance coupling method with reference to FIG. 7A or 7B.

On the other hand, the power receiving unit 291 may further include a rectifier and a regulator to convert the wireless power signal into a direct current. Furthermore, the power receiving unit 291 may further include a circuit for protecting an overvoltage or overcurrent from being generated by the received power signal.

The power reception control unit 292 may control each constituent element included in the power supply unit 290.

Specifically, the power reception control unit 292 may transfer a power control message to the wireless power transmitter 100. The power control message may instruct the wireless power transmitter 100 to initiate or terminate a transfer of the wireless power signal. Furthermore, the power control message may instruct the wireless power transmitter 100 to control a characteristic of the wireless power signal.

In exemplary embodiments, the power reception control unit 292 may transmit the power control message through the wireless power signal. In another exemplary embodiment, the power reception control unit 292 may transmit the power control message through a method for transmitting user data.

In order to transmit the power control message, the electronic device 200 may further include a modulation/demodulation unit 293 electrically connected to the power receiving unit 291. The modulation/demodulation unit 293, similarly to the case of the wireless power transmitter 100, may be used to transmit the power control message through the wireless power signal. The power communications modulation/demodulation unit 293 may be used as a means for controlling a current and/or voltage flowing through the power conversion unit 111 of the wireless power transmitter 100. Hereinafter, a method for allowing the power communications modulation/demodulation unit 113 or 293 at the side of the wireless power transmitter 100 and at the side of the electronic device 200, respectively, to be used to transmit and receive a power control message through a wireless power signal will be described.

A wireless power signal formed by the power conversion unit 111 is received by the power receiving unit 291. At this time, the power reception control unit 292 may control the power communications modulation/demodulation unit 293 at the side of the electronic device 200 to modulate the wireless power signal. For instance, the power reception control unit 292 may perform a modulation process such that a power amount received from the wireless power signal is varied by changing a reactance of the modulation/demodulation unit 293 connected to the power receiving unit 291. The change in a power amount received from the wireless power signal may result in the change of a current and/or voltage of the power conversion unit 111 for forming the wireless power signal. At this time, the modulation/demodulation unit 113 at the side of the wireless power transmitter 100 may detect a change of the current and/or voltage to perform a demodulation process.

In other words, the power reception control unit 292 may generate a packet including a power control message intended to be transferred to the wireless power transmitter 100 and modulate the wireless power signal to allow the packet to be included therein, and the power transmission control unit 112 may decode the packet based on a result of performing the demodulation process of the power communications modulation/demodulation unit 113 to acquire the power control message included in the packet. A detailed method of acquiring the power control message by the wireless power transmitter 100 will be explained later with reference to FIGS. 11a to 13.

In addition, the power reception control unit 292 may transmit a power control message to the wireless power transmitter 100 by transmitting user data including the power control message by a communication means (not shown) included in the electronic device (or wireless power receiver) 200.

In addition, the power supply unit 290 may further include a charger (or charging unit) 298 and a battery 299.

The electronic device 200 receiving power for operation from the power supply unit 290 may be operated by power transferred from the wireless power transmitter 100, or operated by charging the battery 299 using the transferred power and then receiving the charged power. At this time, the power reception control unit 292 may control the charger (or charging unit) 298 to perform charging using the transferred power.

In accordance with one exemplary embodiment disclosed herein, a plurality of electronic devices may receive power transferred from the wireless power transmitter 100. In this case, wireless power signals which are modulated by the plurality of electronic devices may collide with each other. Therefore, the constituent elements included in the wireless power transmitter 100 may execute various operations for avoiding the collision of the modulated wireless power signals.

In accordance with one exemplary embodiment, the power receiving unit 291 may receive a wireless power signal for power transfer from the wireless power transmitter.

Here, the power reception control unit 292 may control the power receiving unit 291 to transmit a third response signal, corresponding to the wireless power signal, after a time interval set for a first time within a first response period (Tping interval_1).

In accordance with one exemplary embodiment, the power reception control unit 292 may determine whether or not the power transfer of the wireless power transmitter 100 has been reset due to the collision of the modulated wireless power signals, and set the time interval to a second time when the power transfer has been reset based on the determination result.

In accordance with one exemplary embodiment disclosed herein, the power reception control unit 292 may control the power receiving unit 291 to transmit a fourth response signal, corresponding to the wireless power signal, after the time interval set for the second time within a second response period (Tping interval_2). The second time may be decided based on a value obtained by generating random numbers.

Hereinafter, description will be given of a wireless power transmitter and an electronic device to which exemplary embodiments disclosed herein is applicable.

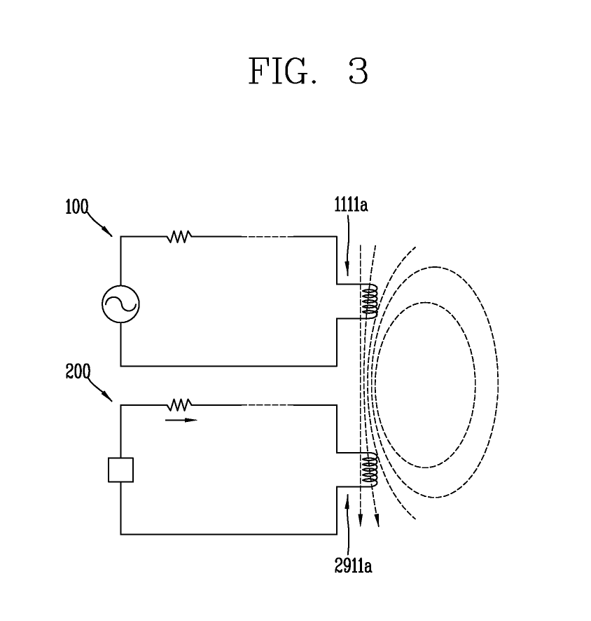

First, a method of allowing the wireless power transmitter to transfer power to the electronic device according to an inductive coupling method will be described with reference to FIGS. 3 through 5.

FIG. 3—Inductive Coupling Method

FIG. 3 is a view illustrating a concept in which power is transferred from a wireless power transmitter to an electronic device in a wireless manner according to an inductive coupling method.

When the power of the wireless power transmitter 100 is transferred in an inductive coupling method, if the strength of a current flowing through a primary coil within the power transmission unit 110 is changed, then a magnetic field passing through the primary coil will be changed by the current. The changed magnetic field generates an induced electromotive force at a secondary coil in the electronic device 200.

According to the foregoing method, the power conversion unit 111 of the wireless power transmitter 100 may include a transmitting (Tx) coil 1111a being operated as a primary coil in magnetic induction. Furthermore, the power receiving unit 291 of the electronic device 200 may include a receiving (Rx) coil 2911a being operated as a secondary coil in magnetic induction.

First, the wireless power transmitter 100 and the electronic device 200 may be disposed in such a manner that the transmitting (Tx) coil 1111a at the side of the wireless power transmitter 100 and the receiving coil at the side of the electronic device 200 are located adjacent to each other. Then, if the power transmission control unit 112 controls a current of the transmitting (Tx) coil 1111a to be changed, then the power receiving unit 291 may control power to be supplied to the electronic device 200 using an electromotive force induced to the receiving (Rx) coil 2911a.

The efficiency of wireless power transfer by the inductive coupling method may be little affected by a frequency characteristic, but affected by an alignment and distance between the wireless power transmitter 100 and the electronic device 200 including each coil.

On the other hand, in order to perform wireless power transfer in the inductive coupling method, the wireless power transmitter 100 may be configured to include an interface surface (not shown) in the form of a flat surface. One or more electronic devices may be placed at an upper portion of the interface surface, and the transmitting (Tx) coil 1111a may be mounted at a lower portion of the interface surface. In this case, a vertical spacing is formed in a small-scale between the transmitting (Tx) coil 1111a mounted at a lower portion of the interface surface and the receiving (Rx) coil 2911a of the electronic device 200 placed at an upper portion of the interface surface, and thus a distance between the coils becomes sufficiently small to efficiently implement contactiess power transfer by the inductive coupling method.

Furthermore, an alignment indicator (not shown) indicating a location where the electronic device 200 is to be placed may be disposed at an upper portion of the interface surface. The alignment indicator may indicate a location of the electronic device 200 where an alignment between the transmitting (Tx) coil 1111a mounted at a lower portion of the interface surface and the receiving (Rx) coil 2911a can be suitably implemented. The alignment indicator may alternatively be simple marks, or may be formed in the form of a protrusion structure for guiding the location of the electronic device 200. Otherwise, the alignment indicator may be formed in the form of a magnetic body such as a magnet mounted at a lower portion of the interface surface, thereby guiding the coils to be suitably arranged by mutual magnetism to a magnetic body having an opposite polarity mounted within the electronic device 200.

On the other hand, the wireless power transmitter 100 may be formed to include one or more transmitting coils. The wireless power transmitter 100 may selectively use some of coils suitably arranged with the receiving (Rx) coil 2911a of the electronic device 200 among the one or more transmitting coils to enhance the power transmission efficiency. The wireless power transmitter 100 including the one or more transmitting coils will be described later with reference to FIG. 5.

Hereinafter, a configuration of the wireless power transmitter and electronic device using an inductive coupling method applicable to the embodiments disclosed herein will be described in detail.

FIGS. 4A and 4B—Wireless Power Transmitter and Electronic Device Using Inductive Coupling Method

FIG. 4A and FIG. 4B are a block diagram illustrating part of the wireless power transmitter 100 and the electronic device 200 in a magnetic induction method that can be employed in the embodiments disclosed herein. A configuration of the power transmission unit 110 included in the wireless power transmitter 100 will be described with reference to FIG. 4A, and a configuration of the power supply unit 290 included in the electronic device 200 will be described with reference to FIG. 4B.

Referring to FIG. 4A, the power conversion unit 111 of the wireless power transmitter 100 may include a transmitting (Tx) coil 1111a and an inverter 1112.

The transmitting (Tx) coil 1111a may form a magnetic field corresponding to the wireless power signal according to a change of current as described above. The transmitting (Tx) coil 1111a may alternatively be implemented with a planar spiral type or cylindrical solenoid type.

The inverter 1112 may transform a DC input obtained from the power supply unit 190 into an AC waveform. The AC current transformed by the inverter 1112 may drive a resonant circuit including the transmitting (Tx) coil 1111a and a capacitor (not shown) to form a magnetic field in the transmitting (Tx) coil 1111a.

In addition, the power conversion unit 111 may further include a positioning unit 1114.

The positioning unit 1114 may move or rotate the transmitting (Tx) coil 1111a to enhance the effectiveness of contactless power transfer using the inductive coupling method. As described above, it is because an alignment and distance between the wireless power transmitter 100 and the electronic device 200 including a primary coil and a secondary coil may affect power transfer using the inductive coupling method. In particular, the positioning unit 1114 may be used when the electronic device 200 does not exist within an active area of the wireless power transmitter 100.

Accordingly, the positioning unit 1114 may include a drive unit (not shown) for moving the transmitting (Tx) coil 1111a such that a center-to-center distance of the transmitting (Tx) coil 1111a of the wireless power transmitter 100 and the receiving (Rx) coil 2911a of the electronic device 200 is within a predetermined range, or rotating the transmitting (Tx) coil 1111a such that the centers of the transmitting (Tx) coil 1111a and the receiving (Rx) coil 2911a are overlapped with each other.

For this purpose, the wireless power transmitter 100 may further include a detection unit (not shown) made of a sensor for detecting the location of the electronic device 200, and the power transmission control unit 112 may control the positioning unit 1114 based on the location information of the electronic device 200 received from the location detection sensor.

Furthermore, to this end, the power transmission control unit 112 may receive control information on an alignment or distance to the electronic device 200 through the power communications modulation/demodulation unit 113, and control the positioning unit 1114 based on the received control information on the alignment or distance.

If the power conversion unit 111 is configured to include a plurality of transmitting coils, then the positioning unit 1114 may determine which one of the plurality of transmitting coils is to be used for power transmission. The configuration of the wireless power transmitter 100 including the plurality of transmitting coils will be described later with reference to FIG. 5.

On the other hand, the power conversion unit 111 may further include a power sensing unit 1115. The power sensing unit 1115 at the side of the wireless power transmitter 100 may monitor a current or voltage flowing into the transmitting (Tx) coil 1111a. The power sensing unit 1115 may be provided to check whether or not the wireless power transmitter 100 is normally operated, and thus the power sensing unit 1115 may detect a voltage or current of the power supplied from the outside, and check whether the detected voltage or current exceeds a threshold value. The power sensing unit 1115, although not shown, may include a resistor for detecting a voltage or current of the power supplied from the outside and a comparator for comparing a voltage value or current value of the detected power with a threshold value to output the comparison result. Based on the check result of the power sensing unit 1115, the power transmission control unit 112 may control a switching unit (not shown) to cut off power applied to the transmitting (Tx) coil 1111a.

Referring to FIG. 4B, the power supply unit 290 of the electronic device 200 may include a receiving (Rx) coil 2911a and a rectifier (or rectifying) circuit 2913.

A current may be induced into the receiving (Rx) coil 2911a by a change of the magnetic field formed in the transmitting (Tx) coil 1111a. The implementation type of the receiving (Rx) coil 2911a may be a planar spiral type or cylindrical solenoid type similarly to the transmitting (Tx) coil 1111a.

Furthermore, series and parallel capacitors may be configured to be connected to the receiving (Rx) coil 2911a to enhance the effectiveness of wireless power reception or perform resonant detection.

The receiving (Rx) coil 2911a may be in the form of a single coil or a plurality of coils.

The rectifier circuit 2913 may perform a full-wave rectification to a current to convert alternating current into direct current. The rectifier circuit 2913, for instance, may be implemented with a full-bridge rectifier generation circuit made of four diodes or a circuit using active components.

In addition, the rectifier circuit 2913 may further include a regulator circuit for converting a rectified current into a more flat and stable direct current. Furthermore, the output power of the rectifier circuit 2913 may be supplied to each constituent element of the power supply unit 290. Furthermore, the rectifier circuit 2913 may further include a DC-DC converter for converting output DC power into a suitable voltage to adjust it to the power required for each constituent element (for instance, a circuit such as a charger (or charging unit) 298).

The power communications modulation/demodulation unit 293 may be connected to the power receiving unit 291, and may be configured with a resistive element in which resistance varies with respect to direct current, and may be configured with a capacitive element in which reactance varies with respect to alternating current. The power reception control unit 292 may change the resistance or reactance of the power communications modulation/demodulation unit 293 to modulate a wireless power signal received to the power receiving unit 291.

On the other hand, the power supply unit 290 may further include a power sensing unit 2914. The power sensing unit 2914 at the side of the electronic device 200 monitors a voltage and/or current of the power rectified by the rectifier circuit 2913, and if the voltage and/or current of the rectified power exceeds a threshold value as a result of monitoring, then the power reception control unit 292 transmits a power control message to the wireless power transmitter 100 to transfer suitable power.

FIG. 5—Wireless Power Transmitter Including One or More Transmitting Coils

FIG. 5 is a block diagram illustrating a wireless power transmitter configured to have one or more transmitting coils receiving power according to an inductive coupling method that can be employed in the embodiments disclosed herein.

Referring to FIG. 5, the power conversion unit 111 of the wireless power transmitter 100 according to the embodiments disclosed herein may include one or more transmitting coils 1111a-1 to 1111a-n. The one or more transmitting coils 1111a-1 to 1111a-n may be an array of partly overlapping primary coils. An active area may be determined by some of the one or more transmitting coils.

The one or more transmitting coils 1111a-1 to 1111a-n may be mounted at a lower portion of the interface surface. Furthermore, the power conversion unit 111 may further include a multiplexer 1113 for establishing and releasing the connection of some of the one or more transmitting coils 1111a-1 to 1111a-n.

Upon detecting the location of the electronic device 200 placed at an upper portion of the interface surface, the power transmission control unit 112 may take the detected location of the electronic device 200 into consideration to control the multiplexer 1113, thereby allowing coils that can be placed in an inductive coupling relation to the receiving (Rx) coil 2911a of the electronic device 200 among the one or more transmitting coils 1111a-1 to 1111a-n to be connected to one another.

For this purpose, the power transmission control unit 112 may acquire the location information of the electronic device 200. For example, the power transmission control unit 112 may acquire the location of the electronic device 200 on the interface surface by the location detection unit (not shown) provided in the wireless power transmitter 100. For another example, the power transmission control unit 112 may alternatively receive a power control message indicating a strength of the wireless power signal from an object on the interface surface or a power control message indicating the identification information of the object using the one or more transmitting coils 1111a-1 to 1111a-n, respectively, and determines whether it is located adjacent to which one of the one or more transmitting coils based on the received result, thereby acquiring the location information of the electronic device 200.

On the other hand, the active area as part of the interface surface may denote a portion through which a magnetic field with a high efficiency can pass when the wireless power transmitter 100 transfers power to the electronic device 200 in a wireless manner. At this time, a single transmitting coil or one or a combination of more transmitting coils forming a magnetic field passing through the active area may be designated as a primary cell. Accordingly, the power transmission control unit 112 may determine an active area based on the detected location of the electronic device 200, and establish the connection of a primary cell corresponding to the active area to control the multiplexer 1113, thereby allowing the receiving (Rx) coil 2911a of the electronic device 200 and the coils belonging to the primary cell to be placed in an inductive coupling relation.

In the meantime, upon disposing one or more electronic devices 200 on an interface surface of the wireless power transmitter 100, which includes the one or more transmitting coils 1111a-1 to 1111a-n, the power transmission control unit 112 may control the multiplexer 1113 to allow the coils belonging to the primary cell corresponding to the position of each electronic device to be placed in the inductive coupling relation. Accordingly, the wireless power transmitter 100 may generate the wireless power signal using different coils, thereby transferring it to the one or more electronic devices in a wireless manner.

Also, the power transmission control unit 112 may set power having a different characteristic to be supplied to each of the coils corresponding to the electronic devices. Here, the wireless power transmitter 100 may transfer power by differently setting a power transfer scheme, efficiency, characteristic and the like for each electronic device. A power transfer for one or more electronic devices will be explained later with reference to FIG. 28.

Furthermore, the power conversion unit 111 may further include an impedance matching unit (not shown) for controlling an impedance to form a resonant circuit with the coils connected thereto.

Hereinafter, a method for allowing a wireless power transmitter to transfer power according to a resonance coupling method will be disclosed with reference to FIGS. 6 through 8.

FIG. 6—Resonance Coupling Method

FIG. 6 is a view illustrating a concept in which power is transferred to an electronic device from a wireless power transmitter in a wireless manner according to a resonance coupling method.

First, resonance will be described in brief as follows. Resonance refers to a phenomenon in which an amplitude of vibration is remarkably increased when periodically receiving an external force having the same frequency as the natural frequency of a vibration system. Resonance is a phenomenon occurring at all kinds of vibrations such as mechanical vibration, electric vibration, and the like. Generally, when exerting a vibratory force to a vibration system from the outside, if the natural frequency thereof is the same as a frequency of the externally applied force, then the vibration becomes strong, thus increasing the width.

With the same principle, when a plurality of vibrating bodies separated from one another within a predetermined distance vibrate at the same frequency, the plurality of vibrating bodies resonate with one another, and in this case, resulting in a reduced resistance between the plurality of vibrating bodies. In an electrical circuit, a resonant circuit can be made by using an inductor and a capacitor.

When the wireless power transmitter 100 transfers power according to the inductive coupling method, a magnetic field having a specific vibration frequency may be formed by alternating current power in the power transmission unit 110. If a resonance phenomenon occurs in the electronic device 200 by the formed magnetic field, then power may be generated by the resonance phenomenon in the electronic device 200.

However, if the plurality of vibrating bodies resonate with each other in an electromagnetic manner as aforementioned, extremely high power transmission efficiency may be exhibited due to non-affection by adjacent objects except for the vibrating bodies. An energy tunnel may be generated between the plurality of vibrating bodies which resonate with each other in the electromagnetic manner. This may be referred to as energy coupling or energy tail.

The resonance coupling disclosed herein may use an electromagnetic wave having a low frequency. When power is transferred using the electromagnetic wave having the low frequency, only a magnetic field may affect an area located within a single wavelength of the electromagnetic wave. This may be referred to as magnetic coupling or magnetic resonance. The magnetic resonance may be generated when the wireless power transmitter 100 and the electronic device 200 are located within the single wavelength of the electromagnetic wave having the low frequency.

Also, as the energy tail is generated in response to the resonance phenomenon, the form of power transmission may exhibit a non-radiative property. Consequently, upon transferring power using such electromagnetic wave, a radiative problem which occurs frequently may be solved.

The resonance coupling method may be a method for transferring power using the electromagnetic wave with the low frequency, as aforementioned. Thus, the transmitting (Tx) coil 1111b of the wireless power transmitter 100 may form a magnetic field or electromagnetic wave for transferring power in principle. However, the resonance coupling method will be described hereinafter from the perspective of a magnetic resonance, namely, a power transmission by a magnetic field.

The resonant frequency may be determined by the following formula in Equation 1.

$$f = \frac{1}{2 π \sqrt{LC}} \qquad [ Equation 1 ]$$

Here, the resonant frequency (f) is determined by an inductance (L) and a capacitance (C) in a circuit. In a circuit forming a magnetic field using a coil, the inductance can be determined by a number of turns of the coil, and the like, and the capacitance can be determined by a gap between the coils, an area, and the like. In addition to the coil, a capacitive resonant circuit may be configured to be connected thereto to determine the resonant frequency.

Referring to FIG. 6, when power is transmitted in a wireless manner according to the resonance coupling method, the power conversion unit 111 of the wireless power transmitter 100 may include a transmitting (Tx) coil 1111b in which a magnetic field is formed and a resonant circuit (or RESONANT GENERATION CIRCUIT) 1116 connected to the transmitting (Tx) coil 1111b to determine a specific vibration frequency. The resonant circuit 1116 may be implemented by using a capacitive circuit (capacitors), and the specific vibration frequency may be determined based on an inductance of the transmitting (Tx) coil 1111b and a capacitance of the resonant circuit 1116.

The configuration of a circuit element of the resonant circuit 1116 may be implemented in various forms such that the power conversion unit 111 forms a magnetic field, and is not limited to a form of being connected in parallel to the transmitting (Tx) coil 1111b as illustrated in FIG. 6.

Furthermore, the power receiving unit 291 of the electronic device 200 may include a resonant circuit 2912 and a receiving (Rx) coil 2911b to generate a resonance phenomenon by a magnetic field formed in the wireless power transmitter 100. In other words, the resonant circuit 2912 may be also implemented by using a capacitive circuit, and the resonant circuit 2912 is configured such that a resonant frequency determined based on an inductance of the receiving coil 2911b and a capacitance of the resonant circuit 2912 has the same frequency as a resonant frequency of the formed magnetic field.

The configuration of a circuit element of the resonant circuit 2912 may be implemented in various forms such that the power receiving unit 291 generates resonance by a magnetic field, and is not limited to a form of being connected in series to the receiving coil 2911b as illustrated in FIG. 6.

The specific vibration frequency in the wireless power transmitter 100 may have LTx, CTx, and may be acquired by using the Equation 1. Here, the electronic device (or wireless power receiver) 200 may generate resonance when a result of substituting the LRx and CRx of the electronic device (or wireless power receiver) 200 to the Equation 1 is same as the specific vibration frequency.

According to a contactless power transfer method by resonance coupling, when the wireless power transmitter 100 and electronic device 200 resonate at the same frequency, respectively, an electromagnetic wave may be propagated through a short-range magnetic field, and thus there may exist no energy transfer between the devices if they have different frequencies.

As a result, efficiency of contactless power transfer by the resonance coupling method may be greatly affected by a frequency characteristic, whereas the effect of an alignment and distance between the wireless power transmitter 100 and the electronic device 200 including each coil may be relatively smaller than the inductive coupling method.

Hereinafter, the configuration of a wireless power transmitter and an electronic device in the resonance coupling method applicable to the embodiments disclosed herein will be described in detail.

FIGS. 7A and 7B—Wireless Power Transmitter Using Resonance Coupling Method

FIGS. 7A and 7B are block diagrams illustrating part of the wireless power transmitter 100 and the electronic device 200 in a resonance method that can be employed in the embodiments disclosed herein.

A configuration of the power transmission unit 110 included in the wireless power transmitter 100 will be described with reference to FIG. 7A.

The power conversion unit 111 of the wireless power transmitter 100 may include a transmitting (Tx) coil 1111b, an inverter 1112, and a resonant circuit (or RESONANT GENERATION CIRCUIT) 1116. The inverter 1112 may be configured to be connected to the transmitting (Tx) coil 1111b and the resonant circuit 1116.

The transmitting (Tx) coil 1111b may be mounted separately from the transmitting (Tx) coil 1111a for transferring power according to the inductive coupling method, but may transfer power in the inductive coupling method and resonance coupling method using one single coil.

The transmitting (Tx) coil 1111b, as described above, may form a magnetic field for transferring power. The transmitting (Tx) coil 1111b and the resonant circuit 1116 may generate vibration when alternating current power is applied thereto, and at this time, a vibration frequency may be determined based on an inductance of the transmitting (Tx) coil 1111b and a capacitance of the resonant circuit 1116.

For this purpose, the inverter 1112 may transform a DC input obtained from the power supply unit 190 into an AC waveform, and the transformed AC current may be applied to the transmitting (Tx) coil 1111b and the resonant circuit 1116.

In addition, the power conversion unit 111 may further include a frequency adjustment unit 1117 for changing a resonant frequency of the power conversion unit 111. The resonant frequency of the power conversion unit 111 may be determined based on an inductance and/or capacitance within a circuit constituting the power conversion unit 111 by Equation 1, and thus the power transmission control unit 112 may determine the resonant frequency of the power conversion unit 111 by controlling the frequency adjustment unit 1117 to change the inductance and/or capacitance. The frequency adjustment unit 1117, for example, may be configured to include a motor for adjusting a distance between capacitors included in the resonant circuit 1116 to change a capacitance, or include a motor for adjusting a number of turns or diameter of the transmitting (Tx) coil 1111b to change an inductance, or include active elements for determining the capacitance and/or inductance.

On the other hand, the power conversion unit 111 may further include a power sensing unit 1115. The operation of the power sensing unit 1115 is the same as the foregoing description.

Referring to FIG. 7B, a configuration of the power supply unit 290 included in the electronic device 200 will be described. The power supply unit 290, as described above, may include the receiving (Rx) coil 2911b and resonant circuit 2912.

In addition, the power receiving unit 291 of the power supply unit 290 may further include a rectifier (or rectifying) circuit 2913 for converting an AC current generated by resonance phenomenon into DC. The rectifier circuit 2913 may be configured similarly to the foregoing description.

Furthermore, the power receiving unit 291 may further include a power sensing unit 2914 for monitoring a voltage and/or current of the rectified power. The power sensing unit 2914 may be configured similarly to the foregoing description.

FIG. 8—Wireless Power Transmitter Including One or More Transmitting Coils

FIG. 8 is a block diagram illustrating a wireless power transmitter configured to have one or more transmission coils receiving power according to a resonance coupling method that can be employed in the embodiments disclosed herein.

Referring to FIG. 8, the power conversion unit 111 of the wireless power transmitter 100 according to the embodiments disclosed herein may include one or more transmitting coils 1111b-1 to 1111b-n and resonant (or RESONANT GENERATION) circuits 1116-1 to 1116-n connected to each transmitting coils. Furthermore, the power conversion unit 111 may further include a multiplexer 1113 for establishing and releasing the connection of some of the one or more transmitting coils 1111b-1 to 1111b-n. The one or more transmitting coils 1111b-1 to 1111b-n may be configured to have the same resonant frequency, or some of them may be configured to have different resonant frequencies. It may be determined by an inductance and/or capacitance of the resonant circuits 1116-1 to 1116-n connected to the one or more transmitting coils 1111b-1 to 1111b-n, respectively.

In the meantime, when one or more electronic devices 200 are disposed in an active area or a detection area of the wireless power transmitter 100 including the one or more transmitting coils 1111b-1 to 1111b-n, the power transmission control unit 112 may control the multiplexer 1113 to allow the electronic devices to be placed in different resonance coupling relations. Accordingly, the wireless power transmitter 100 may wirelessly transfer power to the one or more electronic devices by generating the wireless power signal using different coils.

In addition, the power transmission control unit 112 may set power with a different characteristic to be supplied to each of the coils corresponding to the electronic devices. Here, the wireless power transmitter 100 may transfer power by differently setting a power transmission scheme, a resonant frequency, efficiency, a characteristic and the like for each electronic device. A power transfer for one or more electronic devices will be explained later with reference to FIG. 28.

For this purpose, the frequency adjustment unit 1117 may be configured to change an inductance and/or capacitance of the resonant circuits (1116-1 to 1116-n) connected to the one or more transmitting coils 1111b-1 to 1111b-n, respectively.

FIG. 9—Wireless Power Transmitter Implemented as Charger

Hereinafter, an example of the wireless power transmitter implemented in the form of a wireless charger will be described.

FIG. 9 is a block diagram illustrating a wireless power transmitter further including an additional element in addition to the configuration illustrated in FIG. 2A.

Referring to FIG. 9, the wireless power transmitter 100 may further include a sensor unit 120, a communication unit 130, an output unit 140, a memory 150, and a control unit (or a controller) 180 in addition to the power transmission unit 110 and power supply unit 190 for supporting at least one of the foregoing inductive coupling method and resonance coupling method.

The controller 180 controls the power transmission unit 110, the sensor unit 120, the communication unit 130, the output unit 140, the memory 150, and the power supply unit 190.

The control unit (or Controller) 180 may be implemented by a module separated from the power transmission control unit 112 in the power transmission unit 110 described with reference to FIG. 2A or 2B or may be implemented by a single module.

The sensor unit 120 may include a sensor for detecting the location of the electronic device 200. The location information detected by the sensor unit 120 may be used for allowing the power transmission unit 110 to transfer power in an efficient manner.

For instance, in case of wireless power transfer according to the inductive coupling method, the sensor unit 120 may be operated as a detection unit, and the location information detected by the sensor unit 120 may be used to move or rotate the transmitting (Tx) coil 1111a in the power transmission unit 110.

Furthermore, for example, the wireless power transmitter 100 may be configured to include the foregoing one or more transmitting coils may determine coils that can be placed in an inductive coupling relation or resonance coupling relation to the receiving coil of the electronic device 200 among the one or more transmitting coils based on the location information of the electronic device 200.

On the other hand, the sensor unit 120 may be configured to monitor whether or not the electronic device 200 approaches a chargeable region. The approach or non-approach detection function of the sensor unit 120 may be carried out separately from the function of allowing the power transmission control unit 112 in the power transmission unit 110 to detect the approach or non-approach of the electronic device 200.

The communication unit 130 performs wired or wireless data communication with the electronic device 200. The communication unit 130 may include an electronic component for at least any one of Bluetooth™, Zigbee, Ultra Wide Band (UWB), Wireless USB, Near Field Communication (NFC), and Wireless LAN.

The output unit 140 may include at least one of a display 341 and an audio output unit (or SOUND OUTPUT UNIT) 142. The display 341 may include at least one of a liquid crystal display (LCD), a thin film transistor-liquid crystal display (TFT-LCD), an organic light-emitting diode (OLED), a flexible display, and a three-dimensional (3D) display. The display 341 may display a charging state under the control of the control unit (or controller) 180.

The memory 150 may include at least one storage medium of a flash memory type, a hard disk type, a multimedia card micro type, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, and the like. The wireless power transmitter 100 may operate in association with a web storage performing the storage function of the memory 150 on the Internet. A program or commands performing the foregoing functions of the wireless power transmitter 100 may be stored in the memory 150. The controller 180 may perform the program or commands stored in the memory 150 to transmit power in a wireless manner. A memory controller (not shown) may be used to allow other constituent elements (e.g., controller 180) included in the wireless power transmitter 100 to access the memory 150.

However, it would be easily understood by those skilled in the art that the configuration of a wireless power transmitter according to the embodiment disclosed herein may be applicable to an apparatus, such as a docking station, a terminal cradle device, and an electronic device, and the like, excluding a case where it is applicable to only a wireless charger.

FIG. 10—Wireless Power Receiver Implemented as Mobile Terminal

FIG. 10 is view illustrating a configuration in case where an electronic device 200 according to the embodiments disclosed herein is implemented in the form of a mobile terminal.

The mobile communication terminal 200 may include a power supply unit 290 illustrated in FIG. 2A, 2B, 4A, 4B, 7A or 7B.

Furthermore, the terminal 200 may further include a wireless communication unit 210, an Audio/Video (AN) input unit 220, a user input unit 230, a sensing unit 240, an output unit 250, a memory 260, an interface unit 270, and a controller 280. FIG. 10 illustrates the terminal 100 having various components, but it is understood that implementing all of the illustrated components is not a requirement. Greater or fewer components may alternatively be implemented.

Hereinafter, each component is described in sequence.

The wireless communication unit 210 may typically include one or more modules which permit wireless communications between the terminal 200 and a wireless communication system or between the terminal 200 and a network within which the terminal 200 is located. For example, the wireless communication unit 210 may include a broadcast receiving module 211, a mobile communication module 212, a wireless Internet module 213, a short-range communication module 214, a position location module 215 and the like.

The broadcast receiving module 211 may receive a broadcast signal and/or broadcast associated information from an external broadcast managing entity via a broadcast channel.

The broadcast channel may include a satellite channel and a terrestrial channel. The broadcast center may indicate a server which generates and transmits a broadcast signal and/or broadcast associated information or a server which receives a pre-generated broadcast signal and/or broadcast associated information and sends them to the portable terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may denote information associated with a broadcast channel, a broadcast program, a broadcast service provider, and the like. The broadcast associated information may be provided via a mobile communication network. In this case, it may be received by the mobile communication module 212.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 211 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 211 may be configured to be suitable for every broadcast system transmitting broadcast signals as well as the digital broadcasting systems.

Broadcast signals and/or broadcast associated information received via the broadcast receiving module 211 may be stored in a suitable device, such as a memory 260.

The mobile communication module 212 may transmit/receive wireless signals to/from at least any one of a base station, an external portable terminal, and a server on a mobile communication network. The wireless signal may include audio call signal, video (telephony) call signal, or various formats of data according to transmission/reception of text/multimedia messages.

The wireless internet module 213 may support wireless Internet access for the mobile terminal 200. This module may be internally or externally coupled to the terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 214 may denote a module for short-range communications. Suitable technologies for implementing this module may include Bluetooth, Radio Frequency IDentification (RFID), Infrared Data Association (IrDA), Ultra-WideBand (UWB), ZigBee®, and the like. On the other hand, Universal Serial Bus (USB), IEEE 1394, Thunderbolt of Intel technology, and the like, may be used for wired short-range communication.

The wireless internet module 213 or the short-range communication module 214 may establish data communication connection to the wireless power transmitter 100.

Through the established data communication, when there is an audio signal to be outputted while transferring power in a wireless manner, the wireless internet module 213 or the short-range communication module 214 may transmit the audio signal to the wireless power transmitter 100 through the short-range communication module. Furthermore, through the established data communication, when there is information to be displayed, the wireless internet module 213 or the short-range communication module 214 may transmit the information to the wireless power transmitter 100. Otherwise, the wireless internet module 213 or the short-range communication module 214 may transmit an audio signal received through a microphone integrated in the wireless power transmitter 100. Furthermore, the wireless internet module 213 or the short-range communication module 214 may transmit the identification information (e.g., phone number or device name in case of a portable phone) of the mobile terminal 200 to the wireless power transmitter 100 through the established data communication.

The position location module 215 is a module for acquiring a position of the terminal. An example of the position location module 215 may include a Global Position System (GPS) module.

Referring to FIG. 10, the NV input unit 220 may be configured to provide audio or video signal input to the portable terminal. The AN input unit 220 may include a camera 221 and a microphone 222. The camera 221 may process image frames of still or moving images obtained by an image sensor in a video call mode or a capture more. The processed image frames may be displayed on the display unit 251.

The image frames processed by the camera 221 may be stored in the memory 260 or transmitted to the exterior via the wireless communication unit 210. Two or more cameras 221 may be provided therein according to the use environment.

The microphone 222 may receive an external audio signal by a microphone in a phone call mode, a recording mode, a voice recognition mode, or the like to process it into electrical audio data. The processed audio data may be converted and outputted into a format transmittable to a mobile communication base station via the mobile communication module 212 in case of the phone call mode. The microphone 222 may include various noise removal algorithms to remove noises generated while receiving the external audio signal.

The user input unit 230 may generate input data to allow the user to control the operation of the terminal. The user input unit 230 may include a keypad, a dome switch, a touchpad (e.g., static pressure/capacitance), a jog wheel, a jog switch and the like.

The sensing unit 240 may include a proximity sensor 241, a pressure sensor 242, a motion sensor 243, and the like. The proximity sensor 241 may detect an object approaching the mobile terminal 200, or the presence or absence of an object existing adjacent to the mobile terminal 200, and the like without any mechanical contact. The proximity sensor 241 may detect a proximity object using a change of the AC magnetic field or static magnetic field, a change rate of the electrostatic capacity, or the like. Two or more proximity sensors 241 may be provided according to the aspect of configuration.

The pressure sensor 242 may detect whether or not a pressure is applied to the mobile terminal 200, a size of the pressure, and the like. The pressure sensor 242 may be provided at a portion where the detection of a pressure is required in the mobile terminal 200 according to the use environment. When the pressure sensor 242 is provided in the display unit 251, it may be possible to identify a touch input through the display unit 251 and a pressure touch input by which a pressure larger than the touch input is applied according to a signal outputted from the pressure sensor 242. Furthermore, it may be possible to know a size of the pressure applied to the display unit 251 during the input of a pressure touch.

The motion sensor 243 may detect the location or movement of the mobile terminal 200 using an acceleration sensor, a gyro sensor, and the like. The acceleration sensor used in the motion sensor 243 may be an element for converting an acceleration change in any one direction into an electrical signal. Two or three axes may be typically integrated into a package to constitute an acceleration sensor, and only one Z-axis may be required according to the use environment. Accordingly, when an acceleration sensor in the direction of X-axis or Y-axis should be used instead of the direction of Z-axis due to any reason, the acceleration sensor may be erected and mounted on a main substrate using a separate piece substrate. Furthermore, the gyro sensor may be a sensor for measuring an angular speed of the mobile terminal 200 in a rotational movement to detect a rotated angle with respect to each reference direction. For instance, the gyro sensor may detect each rotational angle, i.e., azimuth, pitch and roll, with reference to three directional axes.

The output unit 250 may be provided to output visual, auditory, or tactile information. The output unit 250 may include a display unit 251, an audio output module 252, an alarm unit 253, a haptic module 254, and the like.

The display unit 251 may display (output) information processed in the terminal 200. For example, when the terminal is in a phone call mode, the display unit 251 may provide a User Interface (UI) or Graphic User Interface (GUI) associated with the call. When the terminal is in a video call mode or a capture mode, the display unit 251 may display images captured and/or received, UI, or GUI.

The display unit 251 may include at least one of a liquid crystal display (LCD), a thin film transistor-liquid crystal display (TFT-LCD), an organic light-emitting diode (OLED), a flexible display, a three-dimensional (3D) display, and the like.

Some of those displays may be configured as a transparent type or a light transmission type through which the outside is visible, which is referred to as a transparent display. A representative example of the transparent display may include a Transparent OLED (TOLED), or the like. The rear surface of the display unit 151 may also be implemented to be optically transparent. Under this configuration, the user can view an object positioned at a rear side of the terminal body through a region occupied by the display unit 251 of the terminal body.

The display unit 251 may be implemented in two or more in number according to a configured aspect of the terminal 200. For instance, a plurality of the display units 251 may be arranged on one surface to be spaced apart from or integrated with each other, or may be arranged on different surfaces.

Here, if the display unit 251 and a touch sensitive sensor (referred to as a touch sensor) have a layered structure therebetween, the display unit 251 may be used as an input device rather than an output device. The touch sensor may be implemented as a touch film, a touch sheet, a touch pad, and the like.

The touch sensor may be configured to convert changes of a pressure applied to a specific part of the display unit 251, or a capacitance occurring from a specific part of the display unit 251, into electric input signals. Also, the touch sensor may be configured to sense not only a touched position and a touched area, but also a touch pressure.

When touch inputs are sensed by the touch sensors, corresponding signals may be sent to a touch controller. The touch controller may process the received signals, and then transmit corresponding data to the controller 280. Accordingly, the controller 280 may sense which region of the display unit 151 has been touched.

The proximity sensor 241 may be arranged at an inner region of the terminal covered by the touch screen, or near the touch screen. The proximity sensor refers to a sensor to sense the presence or absence of an object approaching a surface to be sensed, or an object disposed near a surface to be sensed, using an electromagnetic field or infrared rays without a mechanical contact. The proximity sensor may have a longer lifespan and a more enhanced utility than a contact sensor.

The proximity sensor may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen may be sensed by changes of an electromagnetic field. In this case, the touch screen (touch sensor) may be categorized into a proximity sensor.

Hereinafter, for the sake of brief explanation, a status that the pointer is positioned to be proximate onto the touch screen without contact will be referred to as a “proximity touch”, whereas a status that the pointer substantially comes in contact with the touch screen will be referred to as a “contact touch”. For the position corresponding to the proximity touch of the pointer on the touch screen, such position corresponds to a position where the pointer faces perpendicular to the touch screen upon the proximity touch of the pointer.

The proximity sensor may sense proximity touch, and proximity touch patterns (e.g., distance, direction, speed, time, position, moving status, etc.). Information relating to the sensed proximity touch and the sensed proximity touch patterns may be output onto the touch screen.

The audio output module 252 may output audio data received from the wireless communication unit 210 or stored in the memory 260, in a call-receiving mode, a call-placing mode, a recording mode, a voice recognition mode, a broadcast reception mode, and so on. The audio output module 252 may output audio signals relating to functions performed in the terminal 200, e.g., sound alarming a call received or a message received, and so on. The audio output module 252 may include a receiver, a speaker, a buzzer, and so on.

The alarm 253 may output signals notifying the occurrence of an event from the terminal 200. The event occurring from the terminal 100 may include call received, message received, key signal input, touch input, and so on. The alarm 253 may output not only video or audio signals, but also other types of signals such as signals notifying occurrence of events in a vibration manner. Since the video or audio signals can be output through the display unit 251 or the audio output unit 252, the display unit 251 and the audio output module 252 may be categorized into part of the alarm 253.

The haptic module 254 may generate various tactile effects which a user can feel. A representative example of the tactile effects generated by the haptic module 254 includes vibration. Vibration generated by the haptic module 254 may have a controllable intensity, a controllable pattern, and so on. For instance, different vibration may be output in a synthesized manner or in a sequential manner.

The haptic module 254 may generate various tactile effects, including not only vibration, but also arrangement of pins vertically moving with respect to a skin being contacted, air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 254 may be configured to transmit tactile effects through the user's direct contact, or the user's muscular sense using a finger or a hand. The haptic module 254 may be implemented in two or more in number according to the configuration of the terminal 200.

The memory 260 may store a program for the processing and control of the controller 280. Alternatively, the memory 260 may temporarily store input/output data (e.g., phonebook data, messages, still images, video and the like). Also, the memory 260 may store data related to various patterns of vibrations and audio output upon the touch input on the touch screen.

In some embodiments, software components including an operating system (not shown), a module performing a wireless communication unit 210 function, a module operating together with the user input unit 230, a module operating together with the A/V input unit 220, a module operating together with the output unit 250 may be stored in the memory 260. The operating system (e.g., LINUX, UNIX, OS X, WINDOWS, Chrome, Symbian, iOS, Android, VxWorks, or other embedded operating systems) may include various software components and/or drivers to control system tasks such as memory management, power management, and the like.

In addition, the memory 260 may store a setup program associated with contactless power transfer or wireless charging. The setup program may be implemented by the controller 280.

Furthermore, the memory 260 may store an application associated with contactless power transfer (or wireless charging) downloaded from an application providing server (for example, an app store). The wireless charging related application may be a program for controlling wireless charging transmission, and thus the electronic device 200 may receive power from the wireless power transmitter 100 in a wireless manner or establish connection for data communication with the wireless power transmitter 100 through the relevant program.

The memory 260 may be implemented using any type of suitable storage medium including a flash memory type, a hard disk type, a multimedia card micro type, a memory card type (e.g., SD or xD memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, and the like. Also, the terminal 200 may be operated in association with a web storage performing the storage function of the memory 160 on the Internet.

The interface unit 270 may generally be implemented to interface the portable terminal with all external devices. The interface unit 270 may allow a data reception from an external device, a power delivery to each component in the terminal 200, or a data transmission from the terminal 200 to an external device. The interface unit 270 may include, for example, wired/wireless headset ports, external charger ports, wired/wireless data ports, memory card ports, ports for coupling devices having an identification module, audio input/output (I/O) ports, video input/output (I/O) ports, earphone ports, and the like.

The identification module may be configured as a chip for storing various information required to authenticate an authority to use the terminal 200, which may include a User Identity Module (UIM), a Subscriber Identity Module (SIM), and the like. Also, the device having the identification module (hereinafter, referred to as ‘identification device’) may be implemented in a type of smart card. Hence, the identification device can be coupled to the terminal 200 via a port.

Also, the interface unit may serve as a path for power to be supplied from an external cradle to the terminal 200 when the terminal 100 is connected to the external cradle or as a path for transferring various command signals inputted from the cradle by a user to the terminal 200. Such various command signals or power inputted from the cradle may operate as signals for recognizing that the terminal 200 has accurately been mounted to the cradle.

The controller 280 may typically control the overall operations of the terminal 200. For example, the controller 280 may perform the control and processing associated with telephony calls, data communications, video calls, and the like. The controller 280 may include a multimedia module 281 for multimedia playback. The multimedia module 281 may be implemented within the controller 280, or implemented separately from the controller 280. Also, the controller 180 may be implemented as a separate module from the power reception control unit 292 within the power supply unit 290, which has been described with reference to FIG. 2A or 2B, or a single module.

The controller 280 can perform a pattern recognition processing so as to recognize a writing input or image drawing input carried out on the touch screen as a text or image.

The controller 280 may perform wired or wireless charging according to the user input or internal input. Here, the internal input may represent a signal for notifying that an induced current generated from a secondary coil within the terminal has been detected.

described above, the power reception control unit 292 within the power supply unit 290 may be implemented to be included in the controller 280, and in the present disclosure, it should be understood that the controller 280 performs the operation by the Power reception control unit 292.

The power supply unit 290 may receive internal and external power under the control of the controller 280 to supply power required for the operation of each constituent element.

The power supply unit 290 may be provided with a battery 299 for supplying power to each constituent element of the terminal 200, and the battery 299 may include a charger(or charging unit) 298 for performing wired or wireless charging.

The present disclosure discloses a mobile terminal as an example of the apparatus for receiving power in a wireless manner, but it would be easily understood by those skilled in the art that the configuration according to the embodiment disclosed herein may be applicable to a stationary terminal, such as a digital TV, a desktop computer, and the like, excluding a case where it is applicable to only the mobile terminal.

A wireless power transmitter (or a wireless power transfer device) 300 is a wireless charger on which a mobile terminal 400 can be laid in a horizontal direction as well as a vertical direction. However, the mobile terminal 400 has a bar-like shape which is long in a vertical direction and narrow in a horizontal direction to correspond to a 16:9 or 4:3 display region. When the mobile terminal 400 is laid on the charger in the vertical or horizontal direction, a receiving unit of the mobile terminal 400 is not always located at a predetermined position, and thus requires for a considerably wide active area. Therefore, in those embodiments of the present invention, the wireless power transmitter 300 is provided with a multi-coil type transmitting unit with a wider active area.

Upon arranging several coils for use, a driving circuit is needed as many as a number of the coils, and a control for an individual coil becomes complicated. When a wireless charger using such several coils is produced, it results in an increased producing cost. As another technology for expanding an active area, a single coil transfer method is inappropriate for a mount-type wireless charger, due to disadvantages of increasing a space for a transfer mechanism and a weight when desiring to apply this method. Therefore, if there is a method of expanding an active area merely by using one transmitting coil with a fixed position other than a plurality of charging coils, it may be very effective.

If trying to achieve such objective simply by increasing a size of a single transmitting coil, a magnetic flux density for each unit area of the transmitting coil is lowered and magnetic coupling force between transmitting and receiving coils is reduced. Accordingly, the active area is not increased as wide as expected and transmission efficiency is lowered. Consequently, appropriate shape and size of the transmitting coil are needed to be chosen to overcome such physical inconsistency. Therefore, this specification provides a wireless power transmitter 300 having a single coil with an active area, which is substantially the same level as or greater than that of a multi-coil, even without use of such multi-coil.

FIG. 11A is a front perspective view of a charger in accordance with one embodiment of the present invention.

A charger 300 (as one example of a wireless power transmitter) includes a first body 310 and a second body 320. The second body 320 may be tiltably connected to the first body 310. This may allow a mobile terminal 400 to be placed on one surface of the second body 320. The second body 320 may be provided with a fixing portion for fixing a position of the mobile terminal 400. The fixing portion, as illustrated as one example, may be formed in a shape protruding from the one surface of the second body 320 by a predetermined size.

Each of the first body 310 and the second body 320 include a case (casing, housing, cover, etc.) forming appearance of the mobile terminal 400.

In this embodiment, the case may be divided into a front case and a rear case. Various types of electronic components are disposed in a space formed between the front case and the rear case. At least one intermediate case may further be disposed between the front case and the rear case.

The cases may be formed by injection-molding a synthetic resin or may also be formed of a metal, for example, stainless steel (STS), titanium (Ti), or the like.

On one of the first body 310 and the second body 320 may be disposed an output unit such as a display unit or an audio output module, a user input unit, a socket 389 configured to supply power to the bodies or an interface (not illustrated) to which an external device is coupled.

The display unit 341 may be provided on an upper surface of the front case. The user input unit 360, the socket 389 and the like may be provided on side surfaces of the front case and the rear case.

The user input unit 360 is manipulated by a user to input commands for controlling operations of the mobile terminal 400, and may include a plurality of manipulation units. The manipulation units may be commonly referred to as a manipulating portion, and any method may be employed if it is a tactile manner allowing the user to perform manipulation with a tactile feeling.

The content received by a first or second manipulation unit may be set in various ways. For example, the first manipulation unit may be used to receive a command such as start, end or the like, and the second manipulation unit may receive a command, such as adjusting a volume level output from the audio output module or adjusting brightness of the display unit.

A mounting surface for placing thereon the mobile terminal which is to be charged is formed on an upper surface of the second body 320. When the mobile terminal 400 is placed on the mounting surface, a detection sensor included in the second body 320 may sense the mobile terminal 400 and thus wireless charging of the mobile terminal 400 can be started.

FIGS. 11B and 11C are status views illustrating examples in which the mobile terminal 400 is arranged to be charged by the charger illustrated in FIG. 11A, respectively.

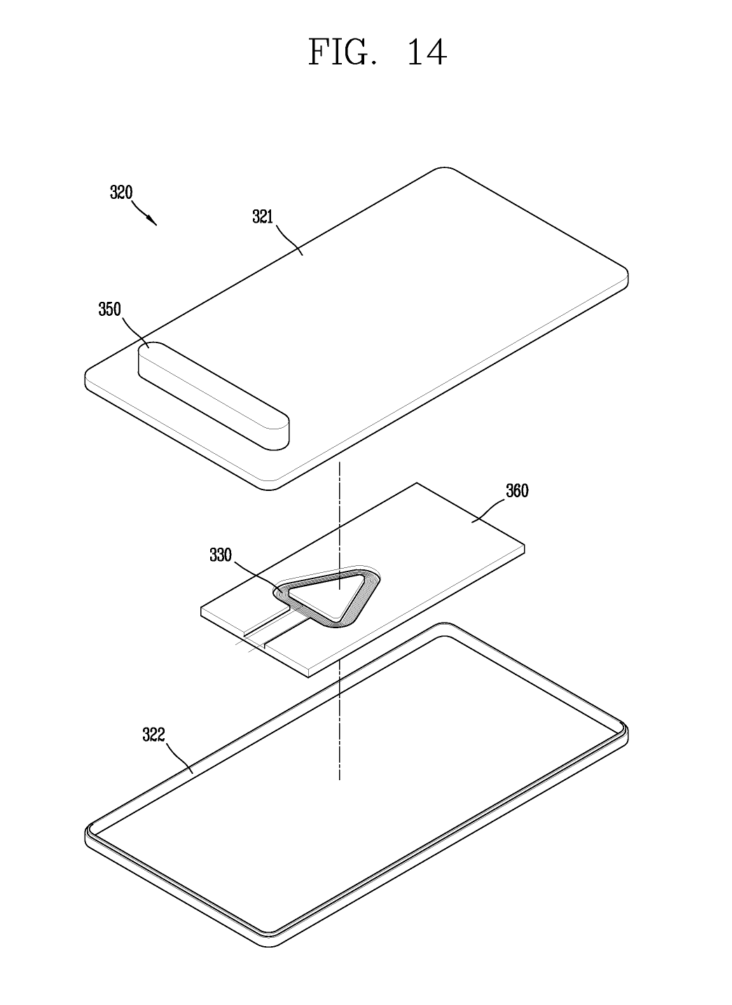

As illustrated in FIGS. 11B and 11C, even while the mobile terminal 400 is erected vertically long or laid horizontally long, a position of the mobile terminal 400 may be supported by the fixing portion 350. Even in the arrangement of the mobile terminal 400, in order to ensure predetermined charging efficiency or more, a transmitting coil with a new structure may be considered. The related embodiments will be described later with reference to FIG. 14 and other drawings.

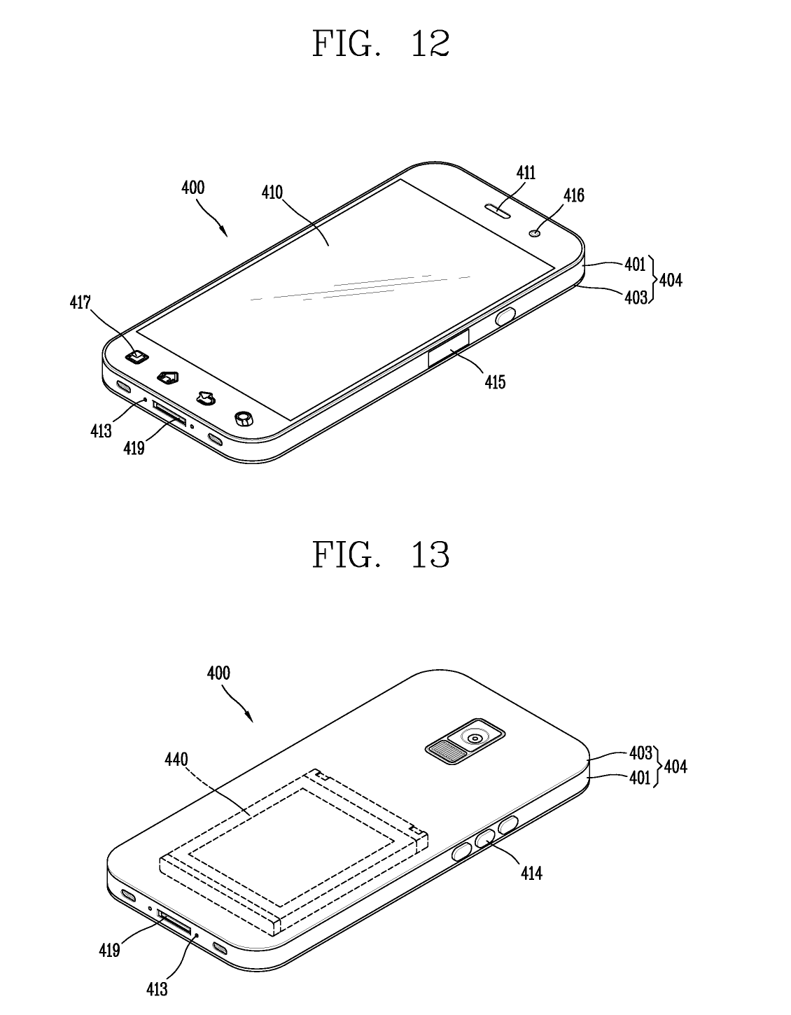

FIG. 12 is a front perspective view of a mobile terminal in accordance with one embodiment disclosed herein, and FIG. 13 is a rear perspective view of the mobile terminal illustrated in FIG. 12.

As illustrated in FIGS. 12 and 13, the mobile terminal 400 includes a bar-like terminal main body 404. However, the present invention may not be limited to this, but may be applicable to various structures such as slide type, folder type, swing type, or the like, in which two and more bodies are combined with each other in a relatively movable manner. In addition, the mobile terminal 400 disclosed in this specification may also be applied to arbitrary portable electronic devices, which have a camera and a flash. Examples of the portable electronic devices may include a cellular phone, a smart phone, a notebook computer, a digital broadcasting terminal, a personal digital assistance (PDA), portable multimedia play (PMO), and the like.

The mobile terminal 400 according to the present invention includes a terminal main body 404 defining its appearance.

A case (casing, housing, cover, etc.) forming the appearance of the terminal main body 404 is formed by a front case 401, a rear case 402, and a battery case 403. The battery case 403 is formed to cover a rear surface of the rear case 402.

Various electronic components may be mounted in a space formed between the front case 401 and the rear case 402. The cases may be formed by injection-molding a synthetic resin or may be also formed of a metal, for example, stainless steel (STS), titanium (Ti), or the like.

A display unit 410, a first audio output module 411, a front camera 416, a side key 414, an interface unit 415, and a signal input unit 417 are provided on a front surface of the terminal main body 404.

The display unit 410 includes a liquid crystal display (LCD) module, an organic light emitting diode (OLED) module, an e-paper and the like, which output visual information. The display unit 410 may include a touch-sensing member for allowing an input in a touching manner. Hereinafter, the display unit 410 having the touch-sensing member is referred to as a ‘touch screen.’ When a touch is made to any one place on the display unit 410, the content corresponding to the touched place is input. The contents entered in the touching manner may be text or numerical values, or menu items which can be instructed or designated in various modes. The touch sensing member may be formed with transparency to allow visual information displayed on the display unit 410 to be seen, and may include a structure for enhancing the visibility of the touch screen at bright places. Referring to FIG. 2, the display unit 410 occupies a most portion of the front surface of the front case 401.

The first audio output module 411 may be implemented in the form of a receiver for transferring voice sounds to the user's ear or a loud speaker for outputting various alarm sounds or multimedia reproduction sounds.

The front camera 416 processes video frames such as still or moving images obtained by the image sensor in a video call mode or capture mode. The processed video frames may be displayed on the display unit 410.

The processed image frames in the front camera 416 may be stored in the memory 160 or externally transmitted through the wireless communication unit 110. Two or more cameras 416 may be provided according to the use environment.

The signal input unit 417 is manipulated by a user to input commands for controlling operations of the mobile terminal 400, and may include a plurality of input keys. The input keys may commonly be referred to as a manipulating portion, and any method may be employed if it is a tactile manner allowing the user to perform manipulation with a tactile feeling.

For example, the signal input unit 417 may be implemented as a dome switch, a touch screen or a touch pad for the user to input commands or information in a pushing or touching manner, or a wheel, a jog or a joy stick for rotating a key. Contents input by the signal input unit 417 may be set in various ways. For example, the signal input unit 417 may be configured to input start, end, scroll and the like.

A side key 414, an interface unit 415 and an audio input module 413 may be provided on side surfaces of the front case 401.

The side key 414 may be referred to as a manipulation unit, and allow the user to input a command for controlling an operation of the mobile terminal. The side key 414 may employ any method if it is a tactile manner allowing the user to perform manipulation with a tactile feeling. Contents input by the side key 414 may be set in various ways. For example, the side key 414 may allow the user to input commands for a control of an image input unit 416, 221, an adjustment of a volume level of sounds output from the audio output module 411, switching of the display unit 410 into a touch recognition mode, or the like.

The audio input module 413 may be implemented, for example, as a microphone for receiving user's voice and other sounds.

The interface unit 415 serves as a path allowing the mobile terminal 400 to interface with external devices. For example, the interface unit 415 may include one or more of a connection terminal for connecting to an earphone in a wired or wireless manner, a port for near field communication {e.g., an Infrared Data Association (IrDA) port, a Bluetooth port, a wireless LAN port, and the like}, or a power supply terminal for supplying power to the mobile terminal 400. The interface unit 415 may be implemented in the form of a socket for accommodating an external card, such as Subscriber Identification Module (SIM), User Identity Module (UIM), or a memory card for information storage.

A power supply unit 440 and a rear supply unit 421 are disposed on a rear surface of the terminal main body 404.

A flash 422 and a mirror (not illustrated) may be disposed adjacent to the rear camera 421. The flash illuminates light toward an object when capturing the object with the rear camera 421.

The mirror allows the user to look at his or her own face, or the like, in a reflected way when capturing himself or herself (in a self-portrait mode) by using the rear camera 421.

The rear camera 421 has an image capturing direction, which is substantially opposite to the direction of the front camera 416 disposed on the front surface, and may have a different number of pixels from that of the front camera 416.

For example, it is preferable that the front camera 416 has a relatively small number of pixels enough not to cause difficulty when the user captures his or her own face and sends it to the other party during a video call or the like, and the rear camera 421 has a relatively large number of pixels since the user often captures a general object that is not sent immediately. The front and rear cameras 416 and 421 may be provided in the terminal main body 404 in a rotatable and popupable manner.

The battery 440 supplies power to the mobile terminal 400. The battery 440 may be mounted in the terminal main body 404 or detachably coupled to an outside of the terminal main body 404.

FIG. 14 is an exploded perspective view of a second body constructing the charger illustrated in FIG. 11A.

As illustrated in FIG. 14, the second body 320 may be a base station which supplies power to a portable electronic device.

The base station is a device for supplying near field inductive power, and has an active area. The active area may be a part of an interface surface of the base station through which a magnetic flux flows when the base station supplies power to the portable electronic device. In this instance, a distance from the coil to one surface (the interface surface) of the base station may be 3.0±0.5 mm.

As illustrated in FIG. 14, a transmitting coil unit 330 may be provided between the front case 321 and the rear case 322. The transmitting coil unit 330 may be configured to be covered with a shielding unit. For example, the transmitting coil unit 330 may be integrally formed with the shielding unit.

In this manner, the transmitting coil unit 330 is mounted to the second body 320, and a controller for controlling an operation of the transmitting coil unit 330 may be disposed in the first body 310. However, the present invention may not be limited to this, and the controller may also be disposed in the second body 320.

The controller may be configured as a type of microcomputer provided on a printed circuit board 340. When the controller is located in the first body 310 other than the second body 320, the second body 320 may be slimmer. When the second body 320 is tilted with respect to the first body 310, the first body 310 and the second body 320 are spaced apart from each other. In this instance, even though shielding efficiency for elements provided on the printed circuit board 340 is slightly reduced, the elements of the printed circuit board 340 may normally operate. That is, when the transmitting coil unit 330 and the controller are arranged in the different bodies from each other, such arrangement may not interfere with the operation of the charger even though the shielding efficiency for the elements of the printed circuit board 340 is reduced. This may allow the shielding unit to be reduced in thickness, thereby implementing the slimmer second body 320.

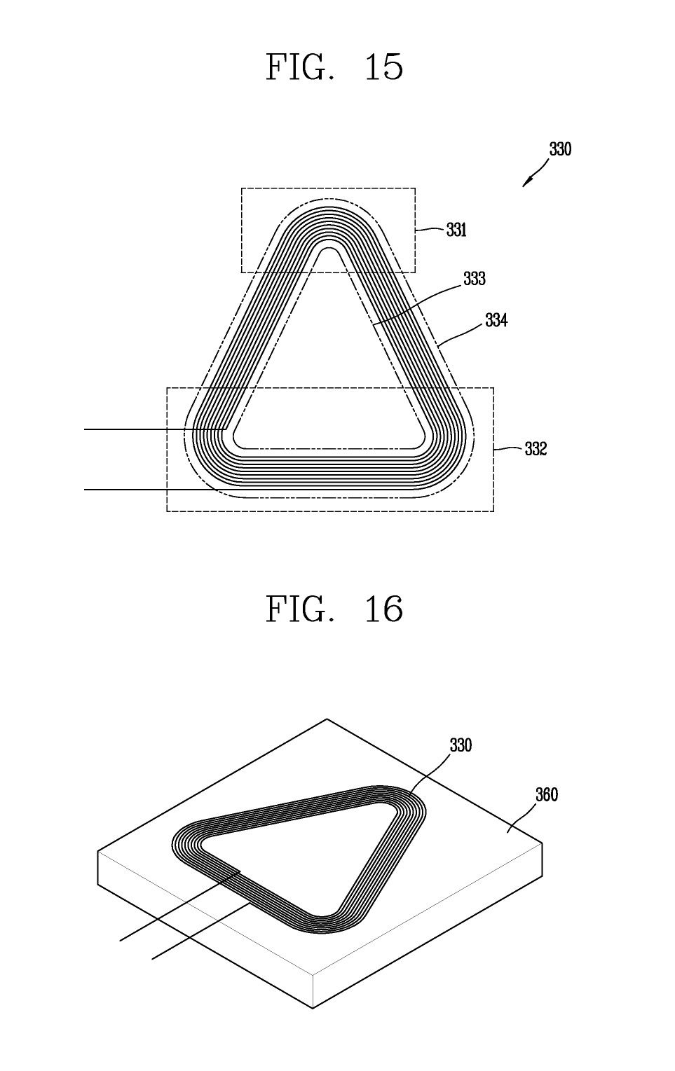

FIG. 15 is a conceptual view illustrating an example of a coil constructing the transmitting coil unit 330, and FIG. 16 is a conceptual view illustrating the transmitting coil unit 330 coupled to a shielding unit 360.

As aforementioned, even while the mobile terminal 400 is erected vertically long or laid horizontally long, in order to ensure predetermined charging efficiency or more, the active area of the transmitting coil unit 330 should be expanded.

In accordance with embodiments of the present invention, a coil (i.e., a primary coil) of the transmitting coil unit 330 is formed in a manner that a wire is wound so as to convert a current into a magnetic flux.

As illustrated, the coil may be configured such that a lower portion 332 thereof has a wider area than an upper portion 331. Here, the lower portion refers to a part of the transmitting coil unit 330 which is close to the ground in a tilted state of the second body 320. The structure can ensure constant charging efficiency, irrespective of the arrangement of the mobile terminal 400 on the second body 320. Here, it is preferable to design a position, at which the maximum magnetic flux is to be generated, to be located at a center of the transmitting coil unit 330. Also, when increasing the number of turns (winding) of a coil for each predetermined area at the upper portion of the transmitting coil unit 330, a magnetic flux density increase. Therefore, higher charging efficiency can be ensured.

As illustrated in FIG. 15, the coil of the transmitting coil unit 330 has a triangular shape and is formed into a single layer. In more detail, the transmitting coil unit 330 may be configured to have the triangular shape with rounded edges (or corners). For example, the coil of the transmitting coil 330 may be arranged in a shape of being wound along sides of an isosceles triangle.

More concretely, the single layer may be formed in a manner that a wire is wound along sides of the isosceles triangle on the same plane, and the isosceles triangle may be a triangle whose height is longer than the base line thereof.

Accordingly, the transmitting coil unit 330 is configured such that the lower portion 332 has a wider area than the upper portion 331. The transmitting coil unit 330 may include a central region 333 which is an empty space without a coil, and a coil region 334 which is formed along an outer circumference of the central region 333 and wound by the coil.

In this instance, the coil may have an outer height (the maximum height of a triangle) of 68±0.5 mm, an outer width (the maximum length of the lower portion) of 59±0.5 mm, an inner height (a height of the central region) of 44±0.5 mm, and an inner width (a length of a lower part of the central region) of 35±0.5 mm. Also, the coil may have a thickness of 1.5±0.5 mm, and the wire may be wound eight (8) times in the single layer.

In this instance, the coil may be formed of a 16 WAG litz wire of 180 strands of a diameter of 0.8 mm or corresponding numerals.

Referring to FIG. 16, the shielding unit 360 may be configured to prevent the elements (e.g., the microprocessor) mounted on the printed circuit board 340 from being electromagnetically affected by the operation of the transmitting coil unit 330, or the transmitting coil unit 330 from being electromagnetically affected by the operations of the elements mounted on the printed circuit board 340. For example, the printed circuit board of the mobile terminal 400 includes a mounted electronic circuit, which is sensitive to electromagnetic interference (EMI) and radio frequency interference (RFI). Specifically, the RFI is generated from an internal or external interference source of the terminal. Therefore, a shielding structure for blocking interference and protecting the electrical elements is needed. The shielding unit 360 may be made of a material, such as stainless steel or titanium, which does not have to be plated.

The shielding unit 360 overlaps the coil. For example, the shielding unit 360 may be disposed between the case (e.g., a rear case) of the base station and the coil.

The shielding unit 360 is formed such that at least part thereof exceeds (or extends more from) an outer diameter of the coil. For example, the shielding unit 360 extends from the outer diameter of the coil by at least 2.5 mm, and is disposed below the coil by the longest distance of 1.0 mm. The upper limit that the shielding unit 360 protrudes from the outer diameter of the coil is not set but may be about 100 mm. Also, the lower limit that the shielding unit 360 is spaced from the coil is not set but may be 0.01 mm.

The shielding unit 360 may also have a thickness of at least 0.7 mm. Even in this instance, the upper limit of the thickness is not set but may be about 10 mm.

Concerning the overall structure of the transmitting coil proposed above, the size, thickness and number of turns of the coil are shown in Table 1, and characteristics of the triangular coil coupled with the shielding unit are shown in Table 2.

TABLE 1

| Parameter | Symbol | Value |
|---|---|---|
| Outer height | H₀ | 68 ± 0.5 mm |
| Inner height | Hᵢ | 44 ± 0.5 mm |
| Outer width | W₀ | 59 ± 0.5 mm |
| Inner width | Wᵢ | 35 ± 0.5 mm |
| Thickness | D_{c} | 1.5 ± 0.5 mm |
| Number of turns per layer | N | 8 |
| Number of layers | | 1 |

TABLE 2

| Parameter | Symbol | Value | |
|---|---|---|---|
| Self Inductance | Lₛ | 7.8 ± 10% | μH |
| [@1 V, 100 khz] | | | |
| Distance from primary coil | D_{z} | 3.0 ± 0.5 | mm |
| to interface surface of | | | |
| base station | | | |

According to the aforementioned shape and numerical values of the single triangle coil, a wireless power transmitter having a single coil which has an active area substantially the same level as or wider than an active area of a multi-coil, even without using the multi-coil, can be implemented.

Also, the single triangular coil according to the present invention may operate in a full-bridge mode and a half-bridge mode, which will be described hereinafter.

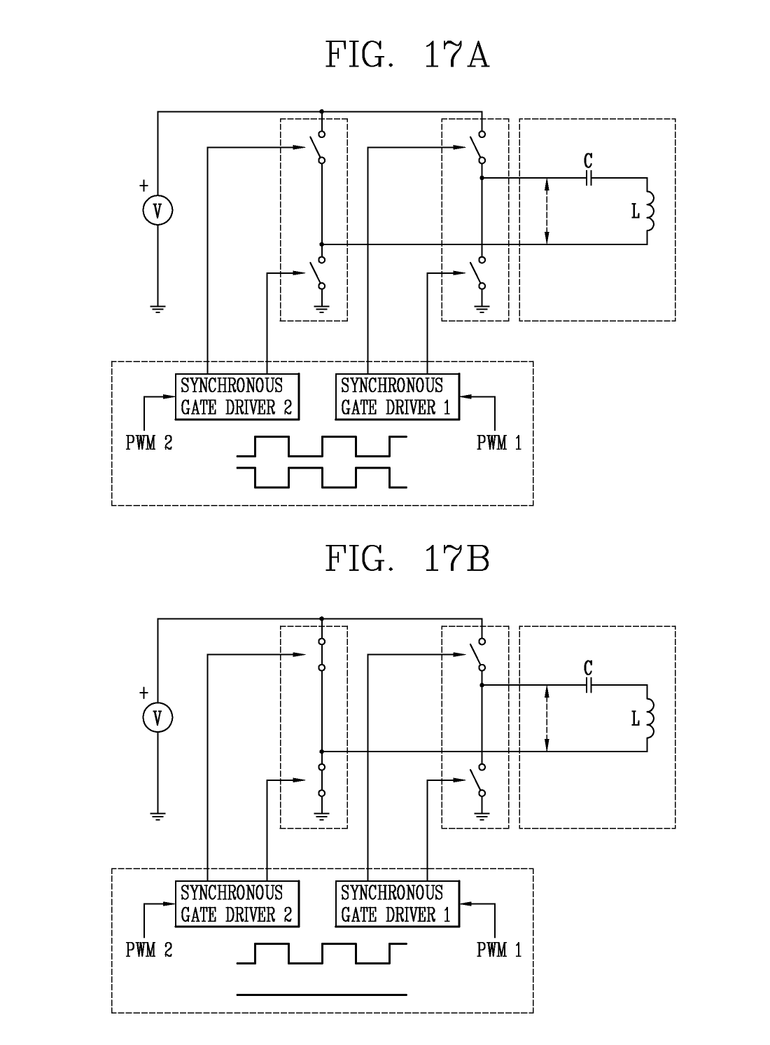

FIGS. 17A and 17B are views illustrating configurations of circuits operating in a full-bridge mode and a half-bridge mode according to the present invention.

As illustrated in FIGS. 17A and 17B, a wireless power transmitter according to the present invention is configured to use full-bridge and half-bridge inverter topologies for operating (or driving) the coil, as well as capacitance. That is, the wireless power transmitter includes a power transfer unit which switches the full-bridge and the half-bridge.

For hardware configuration, as illustrated in FIG. 17A, in the full-bridge mode, a PWM2 pulse of a micom output terminal may be generated in the form of a reversal signal of PWM1 or a phase-shifted form to operate the coil. Also, in the half-bridge mode, referring to FIG. 17B, the PWM2 pulse of the micom output terminal may be shifted to a ground signal to operate the coil, and accordingly, a half-bridge output may be exhibited. Such hardware configuration may be varied into various forms.

Also, self-inductances of the coil and the shielding unit 360 within driving frequency ranges related to the full-bridge and half-bridge inverter topologies may be 7.8±10% μH.

As more detailed numerical values, a driving frequency range may be fₒₚ=110˜205 kHz, and a phase shift range in the full-bridge mode may be 80 to 100%. Also, the driving frequency range may be 50 to 100% at fₒₚ=205 kHz.

A duty cycle rage in the half-bridge mode may be 40 to 50% when fₒₚ=110˜205 kHz, and be 25 to 50% at fₒₚ=205 kHz.

A higher driving frequency or a lower phase or duty cycle may result in the transfer of a lower amount of power. In order to transfer the sufficient amount of power, the driving frequency may be controlled with the following resolution.

0.07×fop−0.5 kHz for fₒₚ in the 110 to 140 kHz range;

0.006×fop−0.4 kHz for fₒₚ in the 140 to 205 kHz range.

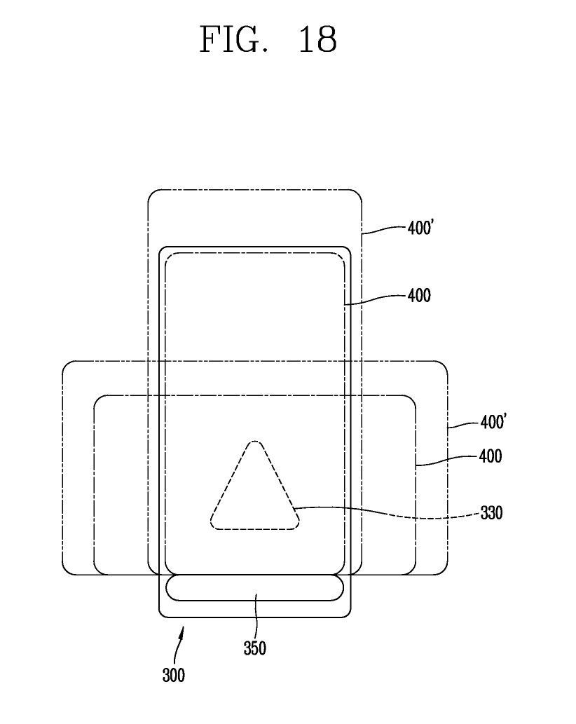

FIG. 18 is a view illustrating that mobile terminals 400 and 400′ are chargeable by the charger, irrespective of sizes or placed positions thereof.

As illustrated in FIG. 18, the mobile terminals 400, 400′ may be placed to be charged by the wireless power transmitter 300. Here, the placed position of each mobile terminal 400, 400′ may be fixed by the fixing unit 350. The mobile terminals 400, 400′ may be erected vertically long or laid horizontally long. The transmitting coil unit 330 of the wireless power transmitter 300 is configured such that its lower portion has the wider area than its upper portion. Therefore, even though being placed vertically long or horizontally long, the mobile terminals 400, 400′ may be charged by the wireless power transmitter 300.

In this manner, regardless of the sizes or placed positions of the mobile terminals 400, 400′, receiving coils of the mobile terminals 400, 400′ may be arranged at a center of the transmitting coil unit 330, whereby charging efficiency can always be uniformly ensured. That is, even when a single coil other than a multi-coil is used, the single coil has an active area the same level as or greater than that of the multi-coil, by virtue of its shape.

The wireless power transmitter described above charges a portable electronic device, such as a mobile terminal, with power. Therefore, the portable electronic device is a wireless power receiver 200. Hereinafter, a wireless power receiver which constructs a wireless charging system together with the wireless power transmitter will be described.

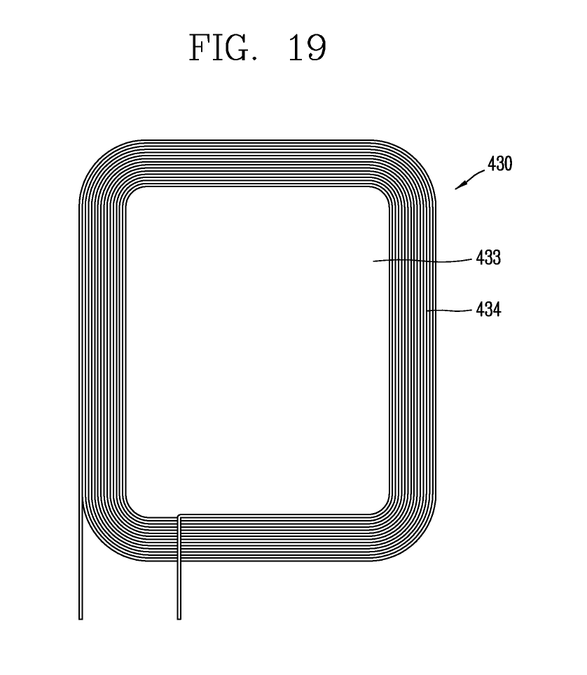

FIG. 19 is a conceptual view illustrating an exemplary coil constructing a receiving coil unit 430 of a wireless power receiver.

According to this embodiment of the present invention, a receiving coil unit 430 may have a rectangular shape with rounded edges (or corners). For example, the receiving coil unit 430 may include a plurality of single coils (secondary coils) wounding along sides of a rectangle, respectively, on a plane.

Similar to the transmitting coil unit, the receiving coil unit 430 may include a central region 433 which is an empty space without a coil, and a coil region 434 which is formed along an outer circumference of the central region 433 and wound by the coil.

In the receiving coil unit 430, the maximum length of a horizontal side may be 43.3±0.3 mm, and the maximum length of a vertical side may be 53.2±0.3 mm. Also, the maximum length of the horizontal side of the central region 433 may be 31.3±0.3 mm, and the maximum length of the vertical side of the central region 433 may be 41.2±0.3 mm. In this instance, the coil may have a form in which two single copper coils are wound on a plane.

The present invention proposes a reference spec of a wireless power receiver as follows.

A single coil layer may have inductance of 14.6±8 pH to 25.5±8 pH, and a resonant frequency of 120±10 kHz. Here, the inductance of the coil layer may be 14.6±8 pH when there is no shielding unit, and 25.5±8 pH when the shielding unit 360 is attached to a lower end of the coil. The single coil layer may have a Q value (or Q factor) of 55 to 65.

For hardware implementation, the methods described herein may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electronic units designed to perform the functions described herein. In some cases, such methods may be implemented by the controller 180 or the power transmission control unit 112 of the wireless power transmitter 100.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180 or the power transmission control unit 112.

However, it would be easily understood by those skilled in the art that the configuration of a wireless power transmitter according to the embodiment disclosed herein may be applicable to an apparatus, such as a docking station, a terminal cradle device, and an electronic device, and the like, excluding a case where it is applicable to only a wireless charger.

The scope of the invention will not be limited to the embodiments disclosed herein, and thus various modifications, variations, and improvements can be made in the present invention without departing from the spirit of the invention, and within the scope of the appended claims.

1. A wireless power transmitter for charging a portable electronic device, the transmitter comprising:
a base station configured to supply power to the portable electronic device;
a coil formed in a manner of winding a wire, and configured to convert a current into a magnetic flux; and
a shielding unit configured to shield the base station from a magnetic field generated in the coil,
wherein the coil is formed into a single layer in a shape of a triangle.

2. The wireless power transmitter of claim 1, wherein the shielding unit overlaps the coil, and at least part thereof exceeds an outer diameter of the Coil.

3. The wireless power transmitter of claim 2, wherein the shielding unit extends from the outer diameter of the coil by at least 2.5 mm, and is arranged below the coil by the maximum distance of 1.0 mm.

4. The wireless power transmitter of claim 2, wherein the shielding unit has a thickness of at least 0.7 mm.

5. The wireless power transmitter of claim 2, further comprising a body tiltably connected to the base station,
wherein the shielding unit is located between a case of the base station and the coil.

6. The wireless power transmitter of claim 1, wherein a distance from the coil to one surface (interface surface) of the base station is 3.0±0.5 mm.

7. The wireless power transmitter of claim 1, wherein full bridge and half-bridge inverter topologies as well as capacitance are used to operate the coil.

8. The wireless power transmitter of claim 7, wherein self-inductances of the coil and the shielding unit within driving frequency ranges related to the full-bridge and half-bridge inverter topologies are 7.8±10% μH.

9. The wireless power transmitter of claim 1, wherein the single layer is formed in a manner that a wire is wound along sides of an isosceles triangle on the same plane.

10. The wireless power transmitter of claim 9, wherein the isosceles triangle has a height longer than a base line thereof.

11. The wireless power transmitter of claim 10, wherein the coil has an outer height of 68±0.5 mm, an outer width of 59±0.5 mm, an inner height of 44±0.5 mm, and an inner width of 35±0.5 mm.

12. The wireless power transmitter of claim 9, wherein the coil has a thickness of 1.5±0.5 mm.

13. The wireless power transmitter of claim 9, wherein the wire is wound eight (8) times in the single layer.

14. The wireless power transmitter of claim 9, wherein the coil is formed of a 16 WAG litz wire of 180 strands of a diameter of 0.8 mm or corresponding numerals.

15. A portable electronic device charged by a wireless power transmitter,
wherein a receiving coil unit of the portable electronic device comprises a coil formed in a manner of winding a wire, and configured to convert a current into a magnetic flux, and
wherein the coil has a rectangular shape and is formed into a single layer, the coil receiving the magnetic flux from a coil of the wireless power transmitter, wherein the coil of the wireless power transmitter is formed into a single layer in a shape of a triangle.

16. A wireless charging system comprising:
a wireless power transmitter configured to transfer power in a wireless manner; and
a portable electronic device configured to receive power in a wireless manner from the wireless power transmitter,
wherein the wireless power transmitter comprises:
a base station configured to supply power to the portable electronic device;
a coil formed in a manner of winding a wire and configured to convert a current into magnetic flux; and
a shielding unit configured to shield the base station from a magnetic field generated in the coil,
wherein the coil is formed into a single layer in a shape of a triangle.
